(19) United States
(12) Patent Application Publication
(10) Pub. No.: US 2024/0220839 A1
(43) Pub. Date: Jul. 4, 2024

(54) PROTOCOL FOR OPTICALLY ENTANGLING DISTINGUISHABLE QUBITS

(71) Applicant: President and Fellows of Harvard College, Cambridge, MA (US)

(72) Inventors: David S. Levonian, Cambridge, MA (US); Ralf RIEDINGER, Cambridge, MA (US); Bartholomeus MACHIELSE, Cambridge, MA (US); Mihir Keshav BHASKAR, Cambridge, MA (US); Mikhail D. LUKIN, Cambridge, MA (US)

(21) Appl. No.: 18/557,493

(22) PCT Filed: Apr. 25, 2022
(86) PCT No.: PCT/US22/26151

§ 371 Date: Oct. 26, 2023

Related U.S. Application Data
(60) Provisional application No. 63/179,770, filed on Apr. 26, 2021.

(51) Int. Cl. G06N 10/40

(52) U.S. Cl. CPC G06N 10/40

(57) ABSTRACT

Systems and methods are disclosed for optically entangling distinguishable qubits. A system can include a first qubit having an optical transition at a first qubit frequency, a second qubit having an optical transition at a second qubit frequency, and a light source producing a first light beam having at least a first frequency. An interferometer can be configured to convert the first light beam into at least one second light beam, to provide the at least one second light beam to the first qubit and the second qubit, and to provide an output light signal. The interferometer can include a first optical modulator that converts the first light beam into the at least one second light beam, and a second optical modulator that produces the output light signal from the at least one second light beam.

### CROSS-REFERENCE TO RELATED APPLICATIONS

This application claims the benefit of priority to U.S. Provisional Application No. 63/179,770, entitled “Protocol for Optically Entangling Distinguishable Qubits,” filed on Apr. 26, 2021, the disclosure of which is hereby incorporated by reference in its entirety.

### STATEMENT OF GOVERNMENTAL INTEREST

This invention was made with government support under Grant Nos. 2012023, 1941583, and 1734011 awarded by National Science Foundation (NSF) and under Grant No. DE-SC0020115 awarded by U.S. Department of Energy (DOE) and under Grant No. W911NF-11-1-0400 awarded by U.S. Army Research Office (ARO). The government has certain rights in this invention.

### TECHNICAL FIELD

The invention relates to quantum computing and quantum information processing.

### COPYRIGHT NOTICE

This disclosure can contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### BACKGROUND

Quantum networks form an important element of quantum computing and quantum communication systems. Quantum networks facilitate the transmission of information in the form of quantum bits, also called qubits. Solid-state quantum emitters, which are capable of producing photons, have recently emerged as candidates for quantum networks. They can combine a number of advantageous properties including electronic spin qubits with long coherence times, fast gates, access to nuclear qubit registers, deterministic qubit fabrication, and/or accessible operating temperatures. Current candidates for scalable quantum information processing with defect centers (e.g., solid state quantum emitters, etc.) cannot deterministically generate high-fidelity entanglement between spatially separated defects. Due to differences in local environment, solid-state emitters can feature a range of distinct transition frequencies, which can make it challenging to create optically mediated entanglement between arbitrary emitter pairs.

### SUMMARY

Systems and methods are disclosed for quantum information processing and/or communication.

In one aspect, a system can include a first qubit having an optical transition at a first qubit frequency, a second qubit having an optical transition at a second qubit frequency, and a light source producing a first light beam having at least a first frequency. The system can also include an interferometer configured to convert the first light beam into at least one second light beam, to provide the at least one second light beam to the first qubit and the second qubit, and to provide an output light signal. The interferometer can include a first optical modulator that converts the first light beam into the at least one second light beam, the at least one second light beam having at least a second frequency and at least a third frequency, the second frequency substantially matching the first qubit frequency and the third frequency substantially matching the second qubit frequency, and a second optical modulator that produces the output light signal from the at least one second light beam, the output light signal having at least a fourth frequency.

In some embodiments, one or more of the first qubit or the second qubit includes a silicon vacancy (SiV) qubit. In some embodiments, one or more of the first qubit or the second qubit comprises a nitrogen vacancy (NV) qubit. In some embodiments, one or more of the first qubit or the second qubit comprises a rare earth ion qubit. In some embodiments, one or more of the first qubit or the second qubit comprises a quantum dot. In some embodiments, one or more of the first qubit or the second qubit comprises a silicon carbide (SiC) defect. In some embodiments, one or more of the first qubit or the second qubit comprise an optically active defect in a silicon crystal.

In some embodiments, the light source includes a laser.

In some embodiments, one or more of the first optical modulator or the second optical modulator includes an electro-optic modulator or an acousto-optic modulator.

In some embodiments, the system further includes a photon detector configured to detect the output light signal. In some embodiments, the photon detector includes a superconducting nanowire single photon detector.

In some embodiments, the output light signal further includes at least one light beam having at least a fifth frequency and the system further comprises an optical filter configured to remove the at least one light beam of at least the fifth frequency from the output light signal before it is detected by the photon detector.

In some embodiments, the system further includes a microwave source configured to generate microwaves at one or more of the first qubit frequency or the second qubit frequency.

In some embodiments, the first qubit reflects or transmits light based on the frequency of the light and a quantum state of the first qubit, and wherein the second qubit reflects or transmits light based on the frequency of the light and a quantum state of the second qubit.

In some embodiments, the second optical modulator shifts a frequency of the light that is transmitted from the first qubit and the second qubit and wherein the second optical modulator does not receive light that is reflected from the first qubit and the second qubit.

In some embodiments, the second optical modulator shifts a frequency of the light that is reflected from the first qubit and the second qubit and wherein the second optical modulator does not receive light that is transmitted from the first qubit and the second qubit.

In some embodiments, the output light signal is dependent on the quantum state of the first qubit and the quantum state of the second qubit such that: when the first qubit and the second qubit are in the same quantum state, either light of the second frequency and light of the third frequency are reflected by the first qubit and the second qubit such that there is no light for the second optical modulator to produce the output light signal or light of the second frequency and light of the third frequency destructively interfere after being modulated by the second optical modulator; and when the first qubit and the second qubit are in different quantum states, either light of the second frequency or light of the third frequency is transmitted to the second optical modulator such that the at least one second light beam is converted into the output light signal.

In some embodiments, the presence of the output light signal indicates that the first qubit and second qubit are in an entangled quantum state.

In some embodiments, the first qubit frequency is different from the second qubit frequency.

In some embodiments, the first qubit frequency differs from the second qubit frequency by greater than 100 MHz, greater than 1 GHz, greater than 5 GHz, greater than 10 GHz, greater than 50 GHz, greater than 80 GHz, or up to 150 GHz.

In some embodiments, the system further includes a microwave source configured to provide a decoupling sequence to one or more of the first qubit or the second qubit to decouple the one or more of the first qubit or the second qubit from environmental noise.

In some embodiments, the decoupling sequence comprises a Hahn Echo sequence.

In some embodiments, the system further includes a third qubit in proximity to the first qubit and a fourth qubit in proximity to the second qubit.

In some embodiments, the first qubit and the second qubit carry quantum information between the third qubit and the fourth qubit.

In some embodiments, one or more of the third qubit or the fourth qubit include a ¹³C or ²⁹Si nuclear spin.

In some embodiments, the interferometer provides the at least one second light beam to both the first qubit and the second qubit in a shared optical path.

In some embodiments, the interferometer provides the at least one second light beam to the first qubit in a first optical path and to the second qubit in a second optical path.

In some embodiments, the at least one second light beam includes a second light beam and a third light beam, and wherein the interferometer provides the second light beam to the first qubit and the third light beam to the second qubit.

In some embodiments, the at least one second light beam includes a single light beam, and wherein the interferometer provides the at least one second light beam to the first qubit and the second qubit in series.

In another aspect, a method of entangling a first qubit having an optical transition at a first qubit frequency and a second qubit having an optical transition at a second qubit frequency, includes: providing a first light beam having at least a first frequency; receiving the first light beam with a first optical modulator; converting, with the first optical modulator, the first light beam into at least one second light beam, the at least one second light beam having at least a second frequency substantially matching the first qubit frequency and at least a third frequency substantially matching the second qubit frequency; providing the at least one second light beam to one or more of the first qubit or the second qubit; and producing, with a second optical modulator, an output light signal having at least a fourth frequency from the at least one second light beam.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE FIGURES

For a more complete understanding of various embodiments of the disclosed subject matter, reference is now made to the following descriptions taken in connection with the accompanying drawings, in which:

FIG. 1 shows schematics of optical entanglement of distinguishable emitters, according to some embodiments of the present disclosure;

FIG. 2 shows schematics of the example implementation, according to some embodiments of the present disclosure;

FIG. 3 shows schematics of the sequence used to entangle the spins, according to some embodiments of the present disclosure;

FIG. 4 shows schematics of a control flow of a test procedure, according to some embodiments of the present disclosure;

FIG. 5 shows reflection spectrum before and after cavity tuning, according to some embodiments of the present disclosure;

FIG. 6 shows time-dependent cavity tuning frequency and EOM lock bias voltage, according to some embodiments of the present disclosure;

FIG. 7 shows optically detected magnetic resonance measurements on two SiV qubits, according to some embodiments of the present disclosure;

FIG. 8 shows measurement results of Rabi driving on two SiV qubits, according to some embodiments of the present disclosure;

FIG. 9 shows measurement results of a simultaneous Hahn Echo performed on two SiV qubits, according to some embodiments of the present disclosure;

FIG. 10 shows measurement results of a DEER sequences performed between two SiV qubits, according to some embodiments of the present disclosure;

FIG. 11 shows fidelity of a Hahn Echo on one SiV qubit as a function of the number of photons detected by the readout, according to some embodiments of the present disclosure;

FIG. 12 shows measurement results of laser scans of the SiV-cavity system, according to some embodiments of the present disclosure;

FIG. 13 shows measurement results of laser scans of the SiV-cavity system, according to some embodiments of the present disclosure;

FIG. 14 shows details of fits of laser scans of the SiV-cavity system, according to some embodiments of the present disclosure;

FIG. 15 shows time-dependent average counts under laser illumination for two SiV qubits, according to some embodiments of the present disclosure;

FIG. 16 shows histograms of photons received after a 10us readout pulse following a pi-half rotation on each SiV qubit, according to some embodiments of the present disclosure; and

FIG. 17 shows schematics for entangling qubits in spatially separated cavities, according to some embodiments of the present disclosure.

### DESCRIPTION

Unlike conventional computers which use bits, i.e., electrical signals representing 1s and 0s, quantum computers use qubits (quantum bits) which can be atomic or subatomic particles such as electrons or photons. While a conventional bit can have a value either 0 or 1, a qubit can have a value either 0, 1, or a quantum superposition of 0 and 1. Qubits have a number of unique properties which quantum computers rely on to achieve their processing speed and power, one of them being quantum entanglement. When a pair of qubits are entangled, the two qubits are in a single quantum state—changing the state of one qubit will instantaneously change the state of the other qubit. An entangled quantum state of two qubits can be measured and established through a parity measurement. The simplest quantum states of two entangled qubits are commonly referred to as Bell states. In some embodiments, a quantum parity measurement is a measurement that tells whether ‘the qubits are pointed in opposite directions’ (e.g., |↑↓ [symbol] or |↑↓ [symbol] ‘the qubits are pointed in the same direction’ (e.g., |↑↑ [symbol] or |↓↓ [symbol] ) without measuring the individual state of either qubit.

Quantum networks, particularly those involving long-distance communications, can be divided into segments. Quantum repeaters can be used for storing and measuring qubits while ensuring high fidelity reproduction of the transmitted quantum state.

To achieve the superior computing power, quantum computers and networks also face a number of challenges. The systems would preferably operate at or nearer to room temperature such that they do not require additional or significant cooling. It is also desirable for the fidelity of the information stored in qubits to not be significantly disturbed by the external environment and to be accurately measurable. The information stored in qubits is preferably kept unchanged for a long period of time (e.g., for storing or transmission) or a long distance before it being read out accurately.

Solid-state quantum emitters are useful in quantum networks (e.g., for qubits and/or communicating information over distances) due to their long-lived spin memories (which can provide long-term storage of information in a spin state), high-fidelity local operations (which can provide accurate control and readout of information stored in a spin state), and optical connectivity for long-range entanglement (which can provide for useful control of and connections between spins). However, due to differences in local environment, solid-state emitters can feature a range of distinct optical transition frequencies. These variations in frequencies can make it challenging to create optically mediated entanglement between arbitrary emitter pairs because the photon emitted by one emitter will be at a frequency that does not match the resonant frequency of the other emitter, preventing it from interacting with the other emitter.

Entanglement mediated by photons can be used for long distance entanglement. Long distance entanglement can be used for quantum repeaters and the creation of quantum networks that communicate information across longer distances using entangled quantum states. Similar to the function of a CMOS transistor gate in conventional computers, qubit gate operations can be applied to qubits to realize arbitrary unitary operations used for quantum computation, including entanglement of qubits. Fast and efficient photon-mediated entangling gates in solid-state emitters can employ light confined in a cavity (cavity quantum electrodynamics (cQED)), with integration of color-centers in nanophotonic resonators to produce reproducible, compact, on-chip architectures. This architecture can be used for Bell state measurements on asynchronously arriving photons, a key capability of quantum repeater stations.

Related-art photonic entanglement schemes have until now been incompatible with the broad distribution of optical transitions commonly exhibited by solid state emitters due to strain and other environmental variations. That is, such entanglement schemes typically rely on qubits that have similar optical properties to one another, but solid state emitters often have significant variation in optical properties due to environmental factors that are difficult to control. For example, using frequency-erasing time-tagging or electrooptical frequency shifting, entanglement of distinguishable memories separated by at most ˜100 MHz may not be able to accommodate the typical frequency spread of ˜5-150 GHz for emitters encountered in micro- and nanophotonic structures. While multi-stage quantum frequency conversion could in some ways compensate for this mismatch, its high noise and low efficiency has restricted its application to conversion from emitter wavelengths to telecommunication wavelengths for long distance communication. While it is possible to select individual quantum emitters to have near-identical optical resonances, or to use systems in which the optical detuning is actively compensated, such schemes can have limited scalability because the former would produce low yield for useable quantum emitters and the latter may require substantial overhead in device complexity.

Embodiments of the present disclosure describe systems and methods to project a pair of qubits into an entangled state without direct interaction between the qubits. In some embodiments, one light beam is split into two light beams with different frequencies, each interacting with one of the qubits, and then recombined together. In some embodiments, the light beam can be reflected or scattered depending on the spin state of the qubit. In some embodiments, the entanglement state of the qubits can be revealed by detecting the recombined light beam.

Embodiments of the present disclosure describe efficient methods for entangling emitters with different optical transition frequencies, such as those separated by many linewidths whereas the linewidth refers to the range of possible photon frequencies that could interact with a given qubit. In some embodiments, electro-optic modulators can enable a single photon to represent a parity measurement on a pair of spin qubits. Embodiments of the present disclosure demonstrate example protocols using two silicon-vacancy centers in a diamond nanophotonic cavity, with optical transitions separated by 7.4 GHz. Working with emitters with different optical transition frequencies allows for individual qubit addressing and readout. It can also enable parallel control and entanglement of both co-located and spatially separated emitters without requiring such qubits to have closely matched optical properties. Thus, this method can be used in larger scale quantum information processing systems.

Embodiments of the present disclosure demonstrate schemes to entangle emitters with slightly or significantly different (which can be referred to as far-detuned) optical transitions which are coupled to an optical cavity. In some embodiments, two silicon-vacancy color centers (SiV) in the same diamond photonic crystal resonator are used, each acting as a spin-dependent scatterer that scatters light depending on its spin state. Embedding the two SiVs in the two arms of an interferometer, an interaction-free measurement can be used to determine if one (and only one) arm is blocked (e.g., a corresponding light beam is scattered), determining the joint spin parity by monitoring a dark port of the interferometer. A frequency domain interferometer can be used to entangle quantum emitters with drastically different optical transition frequencies. Example disclosed schemes are robust against common noise sources in the environment of the spins and can retain high resource efficiency (e.g., the entanglement can be produced with a single photon).

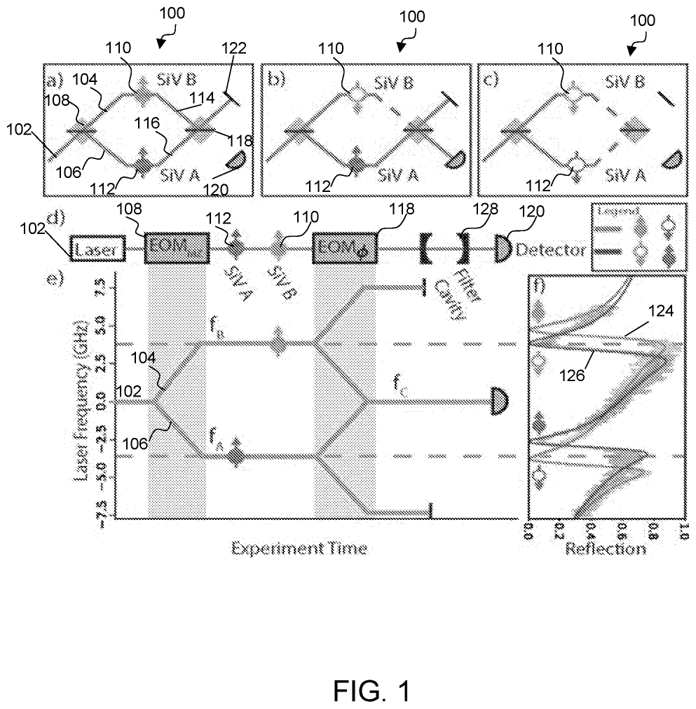

FIG. 1 shows schematics of an interferometer 100 for optical entanglement of distinguishable emitters, according to some embodiments of the present disclosure. In some embodiments, a laser beam 102 is split into two beams 104 and 106 by an electro-optical modulator 108. The two beams 104 and 106 are directed onto two SiVs 110 and 112, respectively. The beams 104 and 106 also form two arms of the interferometer 100. The two SiVs 110 and 112 act as spin-dependent mirrors, producing reflected/scattered lights 114 and 116, respectively. In some embodiments, the spins interact with the optical cavity and shift its resonant frequency. If a light arrives at the resonant frequency of the cavity, it can enter the cavity and scatter. If light arrives at another frequency, it can reflect from the cavity. Thus, certain frequencies of light can conditionally reflect or scatter depending on the state of the spin. In some embodiments, such interference is referred to as Fano interference. The reflected/scattered lights 114 and 116 are combined in a second eletro-optical modulator 118. Depending on the spin states of the SiVs, the combined light may exit from the interferometer 100 through (1) only the top port 122, (2) the top port 122 as well as being received by a photon detector 120, or (3) no light may leave the interferometer 118. Panel (a) of FIG. 1 shows schematics in which the interferometer 118 is tuned so that when no spin in SiVs 110 and 112 scatters light (shown as a full circle) photons leave only through the top port 122 of the interferometer. Panel (b) of FIG. 1 shows that if just one spin scatters (empty circle 110) while the other 112 reflects, light is split between the two output ports and the heralding detector 120 receives photons. Panel (c) of FIG. 1 shows that if both spins 110 and 112 scatter, no light leaves the interferometer.

Panel (d) of FIG. 1 illustrates an exemplary physical implementation of the entanglement protocol, according to some embodiments. In some embodiments, the two SiVs are positioned in line with the optical path of the laser beam. A laser beam 102 is split into two lights with a first electro-optical modulator 108, each light with a different frequency component (f_{A} and f_{B}) and interacts with one of the SiVs 110 and 112. The two SiVs 110 and 112 act as spin-dependent mirrors so that each of the frequency components is conditionally reflected. The two lights output by SiVs 110 and 112 are recombined using a second electro-optical modulator 118. The recombined light passes through a filter cavity 128 which removes the unwanted frequency components before the remaining light is received by the photon detector 120. In some embodiments, the filter cavity rejects all frequencies except the central frequency f_{C}=(f_{A}+f_{B})/2. In some embodiments, the detection at the photon detector indicates that the spins are in an odd parity state. The relative phase between the microwave drive to the two electro-optical modulators (EOMs) EOM_{MZ} 108 and EOMϕ 118, sets the phase difference between the interferometer arms 104 and 106. In some embodiments, the EOM takes an electrical signal and turn it into phase modulation on a light passing through and the microwave input to the EOM produces sidebands.

Panel (e) of FIG. 1 illustrates the operation of the interferometer in the frequency domain, according to some embodiments. The x-axis represents the procedure time. The y-axis shows the relative frequency of the relevant photonic modes f_{A} and f_{B} (i.e., optical transition frequencies) of the two SiVs in the entanglement protocol. Two EOMs 108 and 118 play the role of beam-splitters. The laser light 102 is split into two lights with different frequencies, each interacting with one of the SiVs respectively. Detection of photons at the central frequency f_{C} projects the SiVs into an odd parity state ((|↑ [symbol] or |↓↑ [symbol] [symbol] ), i.e., the interference of the two light beams means that only an odd parity combination of ((|↑↓ [symbol] or |↓↑ [symbol] )) leads to a light at the central frequency.

Panel (f) of FIG. 1 shows measurement results of the reflection spectrum of the two SiVs under investigation, when initialized in |↑↓ [symbol] (126) or |↓↑ [symbol] (124), according to some embodiments. The vertical axis represents the laser frequency, as in panel (e). The horizontal axis shows normalized reflection. The reflection reaches minima when the laser frequency matches one of the optical transition frequencies of the two SiVs. The vertical shift between the two adjacent minima represents the energy difference between the spin up |↑ [symbol] and spin down |↓ [symbol] states due to Zeeman splitting.

According to some embodiments, as shown in FIG. 1 panels (d)-(e), SiV center A and B are detuned from the nanophotonic cavity such that the system exhibits spin-dependent spectral features of high contrast due to Zeeman splitting of the resonances, i.e., the reflection or scattering of the light depends on the spin state of the SiVs. The optical transition of SiV A (or B) is resonant with frequency f_{A} (or f_{B}), if the spin is in the |↓ [symbol] _{a(or b)} state, which results in photons being scattered and lost from the interferometer. Otherwise (for |↑ [symbol] _{a(or b)}), a Fano interference can block the light from entering the cavity (FIG. 1 panel (f)), keeping it in the interferometer. Therefore, the detection of photons at the photon detector 120 can provide information of the spin states of the SiVs. The system described in FIG. 1 can be used to reveal the spin states of a pair of spin qubits with a parity measurement, avoiding detecting the state of either individual qubit. Below is an explanation of example physical phenomena that produce that result.

In some embodiments, in each round, the spins of SiVs A and B can be first initialized in the state

$${{{{{{\vert - 〉}_{A} ⊗ \vert + 〉}_{B} α \vert ↑ ↑ 〉}_{AB} - \vert ↑ ↓ 〉}_{AB} + \vert ↓ ↑ 〉}_{AB} - \vert ↓ ↓ 〉}_{AB} , \qquad ( 1 )$$

with |± [symbol] _{a(or b)}=(|↑ [symbol] _{a(or b)}±|↓ [symbol] _{a(or b)})/\sqrt{2}, and a photon can be prepared in a superposition of two frequency-domain basis states |f_{A}) and |f_{B}):

$${{{\vert ψ 〉}_{p , in} = \frac{1}{\sqrt{2}} ( \vert {f}_{A} 〉}_{p , in} + \vert {f}_{B} 〉}_{p , in} ) . \qquad ( 2 )$$

This can be achieved by sending a photon at frequency f_{C}=(f_{A}+f_{B})/2 through an electro-optic intensity modulator (EOM_{MZ}) (e.g., 108 in FIG. 1) driven at ω=(f_{B}−f_{A})/2 to produce two sidebands at fₐ and f_{B} (e.g., 104 and 106 in FIG. 1) while suppressing the carrier. The photon then encounters the two SiVs, where each frequency component is conditionally reflected into the modes described by annihilation operators â (for f_{A}) and \hat{b} (for f_{B}). Next, the two sidebands are recombined, using a phase modulator (EOM_{Φ}) (e.g., 118 in FIG. 1), yielding the mode described by

$$\hat{c} = \frac{1}{\sqrt{2}} ( {e}^{i Δϕ} \hat{a} + \hat{b} )$$

at frequency f_{C} (Δ_{ϕ} is the relative phase). Finally, the light can be sent through a filter cavity (e.g., 128 in FIG. 1), which rejects the sidebands, and can be detected by a single photon detector (e.g., 120 in FIG. 1).

In some embodiments, the spins are in the |↑↑ [symbol] _{ab} state, both frequency components are reflected (as shown in FIG. 1 panel (a)), such that the probe photon is in state |ψ [symbol] ₚ∝|f_{A} [symbol] ₚ+f_{B} [symbol] ₚ when it arrives at the frequency combiner (EOM_{Φ}) (e.g., 118 in FIG. 1), where |f_{A(or B)} [symbol] ₚ indicates a photon in the mode described by â(or \hat{b}). The interferometer phase Δϕ can be set to π, so that the mode at f_{C} becomes a dark port of the interferometer, with the amplitudes â and \hat{b} interfering destructively. The second EOM transfers the probe photon to the modes at f_{C}±2ω, where it is rejected by the filter cavity. In case of the |↓↓ [symbol] _{ab}state, there is no photon reflection at either f_{A} or f_{B} (as shown in FIG. 1 panel (c)), also resulting in no events at the detector. For |↑↓ [symbol] _{ab} and |↑↓ [symbol] _{ab}, only one of the frequency components is blocked, destroying the interference condition at the final frequency beam-splitter and allowing the photon to pass through the interferometer (as shown in FIG. 1 panel (b)), revealing the spin parity.

In some embodiments, transmission of the photon can imply that it did not encounter the scatterer, but nonetheless reveals the scatterer's presence, a phenomenon termed interaction-free measurement. In some embodiments, an event at the heralding detector does not reveal which frequency-path was blocked, as the photon could originate from either component of the spin-photon state: |ψout [symbol] _{AB,p}˜−|↑↓ [symbol] _{ab}⊗|f_{A} [symbol] ₚ+|↓↑ [symbol] _{ab}⊗|f_{B} [symbol] ₚ. A detection event in mode ĉ thus projects the spins to a maximally entangled Bell state:

$${\vert {Ψ}^{+} 〉}_{AB} = \frac{{{\vert ↑ ↓ 〉}_{AB} + \vert ↓ ↑ 〉}_{AB}}{\sqrt{2}} \qquad ( 3 )$$

This interferometric protocol is both resource efficient and robust. Specifically, a single photon detection is sufficient to herald entanglement, in contrast to two-photon schemes. Nevertheless, as both frequency components of the photon travel on a common path and a common polarization, it is robust to phase fluctuations of the fiber, requiring no active stabilization of the interferometer.

In some embodiments, commercial EOMs and signal generators can be used for generating entanglement between emitters separated by up to |f_{A}−f_{B}|≤80 GHz in the visible and near infrared wavelength range. This range can be extended to 160 GHz by selecting higher order EOM sidebands with spectral filters. This covers the majority of the inhomogeneous distribution of various color centers in nanostructures, such as C:SiV⁻, YSO:Er⁺³, and YSO:Nd⁺³.

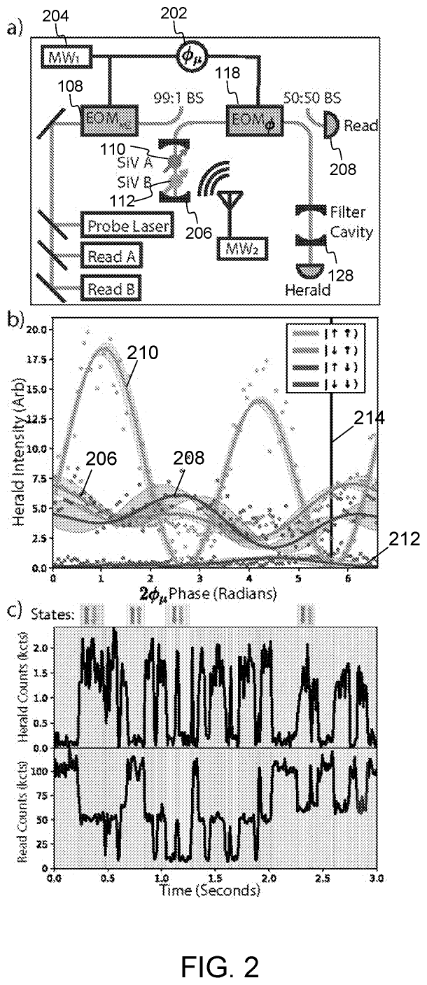

FIG. 2 shows schematics of an example implementation, according to some embodiments of the present disclosure. Panel (a) shows that the relative phase ϕ_{μ} 202 between the microwave drive (MW₁) 204 to the two modulators EOM_{MZ} 108 and EOM_{ϕ} 118 sets the phase difference between the interferometer arms Δϕ=2ϕ_{μ}. Readout of the spin states of SiVs is done sequentially with lasers at fa and fs by detecting a fraction of the light before the filter cavity 128. Panel (b) shows transmission (y-axis) (i.e., the number of photons being detected after the filter cavity) to the heralding port as a function of interferometer phase (x-axis) for all SiV states |↓↑ [symbol] 206, |↑↓ [symbol] 208, |↑↑ [symbol] 208 and |↓↓ [symbol] 212. Transmission predicted by a fit of the spin dependent reflection spectrum as solid lines with variance due to spectral diffusion given by shaded area. Phase and scaling are obtained by fitting the |↑↑ [symbol] state. The black vertical line 214 indicates the phase used to collect the entanglement data. At this phase, the transmission of the |↑↑ [symbol] and |↓↓ [symbol] are minimum so that the odd parity states can be detected. Panel (c) shows quantum jumps (e.g., state changes in the quantum system): transmission through the filter cavity (y-axis in the top panel) and readout port (y-axis in the bottom panel) as a function of time (x-axis) with the entanglement heralding laser applied continuously. The filter transmission is a spin parity measurement, with high transmission corresponding to odd parity (|↑↓ [symbol] or |↓↑ [symbol] ) because a portion of the probe laser is received at the photon detector. Low transmission indicates either |↑↑ [symbol] or |↓↓ [symbol] because the probe laser was reflected or scattered.

As shown in FIG. 2 panel (a), in some embodiments, a pair of SiV-centers (A and B) can be utilized with optical transitions separated by 7.4 GHz, located in the same nanophotonic cavity 206 with cooperativities C_{A}=14.4(1) and C_{B}=6.1(1), respectively. In some embodiments, cooperativity represents how strongly coupled the SiVs and the cavity are. The cavity can be coupled to a waveguide, which adiabatically transfers photons into a tapered fiber with an efficiency of η_{wg}=0.85±0.03. The cavity 206 can be detuned from the SiV transitions to yield high reflection contrast for both SiV A and B (FIG. 1 panel (f)). A magnetic field of B˜0.45 T can be applied along the common symmetry axis of both SiVs to split the spin conserving optical transitions (with probability of spin changing transition r˜2.3×10⁻⁴ per cycle).

To read out SiV A (or B), photons can be injected at frequency f_{A} (or f_{B}) and detect them with a superconducting nanowire single photon detector 208 placed before the filter cavity 128 (FIG. 2 panel (a)). This allows for independent readout of both spin states with fidelity [symbol] _{R,A}=0.9984(1) and [symbol] _{R,B}=0.9991(1). Moreover, the gyromagnetic ratio of SiVs depends significantly on strain, allowing for individual microwave addressing of emitters with the same orientation. Zeeman splitting of the ground state spin states can be found as ω_{ZA}=12.285 GHz and ω_{ZB}=12.627 GHz, allowing feedback-based initialization of the individual spins.

In some embodiments, the spins can be sequentially initialized, via detection of their state and application of a local rotation to each qubit with a resonant microwave pulse to prepare the state |+− [symbol] _{AB}. In some embodiments, without optical input, it can be found that an interleaved Hahn-Echo sequence on both spins with pulses separated by τ₁=412 ns and τ₂=423 ns respectively recovers the initial two-spin-state with a fidelity of [symbol] _{HE,AB}=0.93, consistent with the corresponding individual Hahn-Echo fidelities [symbol] _{HE,A}=0.96 and [symbol] _{HE,B}=0.97. In some embodiments, due to drifts in qubit frequencies, the fidelity is reduced during long measurements (resulting, e.g., in average [symbol] [symbol] _{HE,AB} [symbol] =0.85 over 3 days of measurements).

In some embodiments, the phase of the time-bin interferometer can be tuned by initializing the spins in |↑↑ [symbol] _{AB} and minimizing the transmission through the interferometer (FIG. 2 panel (b)). At an example optimal phase, it can be found that the relative transmission rates T for the four spin states T_{↑↑}:T_{↑↓}:T_{↓↑}:T_{↓↓}=1:14:22:1.2 (FIG. 2 panel (c)). The mismatch in reflection between the two odd parity states |↑↓ [symbol] _{AB}(|↓↑ [symbol] _{AB}) is due to interference of the light reflected by the |↑ [symbol] state by SiV A (or B) with the residual reflection of the |↓ [symbol] state of SiV B (or A) and the leaked carrier at f_{C}, and can therefore vary depending on their relative phases.

In some embodiments, T_{↓↓} can be limited by interference of the finite reflection in the |↓ [symbol] states with the leaked carrier. In some embodiments, for T_{↑↑} the largest contribution to the finite reflection is the spectral diffusion of the two SiV features and the resulting fluctuation in the phase of the reflected light.

In some embodiments, the spins can be entangled by sending a weak coherent laser pulse with an expected photon number of 0.1 at the cavity into the interferometer, striking a balance between success probability and decoherence induced by the scattering of extra, undetected heralding photons. When a photon is detected in transmission of the filter cavity, this heralds that the spins were prepared in an entangled state.

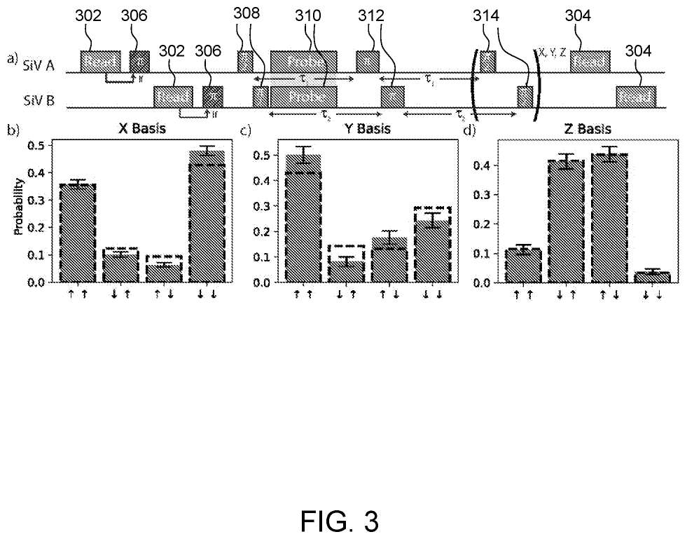

FIG. 3 shows schematics of the sequence used to entangle the spins, according to some embodiments of the present disclosure. Panel (a) shows that initialization 302 and readout 304 both apply 10 μs laser pulses at f_{A} or f_{B}. Counts are subsequently compared to a threshold to determine the state. Initialization follows this with a conditional π pulse 306. Panels (b)-(d) show correlation statistics of the entangled state in XX, YY and ZZ spin bases. In the provided testing data (bars), the measurement was taken with a heralding window (i.e., the time in which the heralding pulse is applied) of 200 ns. Dashed lines are correlations predicted by a theoretical model (which in no way limits the invention). Error bars represent 68% confidence interval.

In some embodiments, to characterize this state, the correlations of the spins of SiV A and B in the X-, Y-, and Z-basis can be sequentially measured (FIG. 3 panels (b)-(d)). This can result in a measured fidelity of

$${ℱ}_{\vert Ψ + 〉} = ( 2 {p}_{↑ ↓} + 2 {p}_{↓ ↑} + {K}_{XX} + {K}_{YY} ) / 4 = 0.71 ( 2 ) \qquad ( 4 )$$

where K_{BB}=p₊₊+p₋₋−p₋₊ is the contrast for basis B=X, Y and p_{ab} is the probability for measuring the spin of SiV A (B) in a(b)∈{+, −} in X- and Y-basis, respectively a(b)∈{↑, ↓} in the Z-basis. This confirms that the spins are entangled ( [symbol] >0.5). As alternative measure of entanglement, a concurrence of C≥0.37(4) can be obtained.

In some embodiments, the results from example tests of the apparatus and/or procedure can be compared to a model based on the spectrum of the cQED system (FIG. 1 panels (c) and (d)). Using the complex reflection coefficient at frequencies f_{A}, f_{B} and f_{C}, a predicted transmission through the interferometer for all four spins states can be obtained (FIG. 2 panel (c)).

Including local qubit errors and accounting for a phase drift of the carrier, the model can predict the correlations of the heralded state (FIG. 3 panels (b)-(d)), and a fidelity of ˜0.67±0.014 (see Table below). The systematic uncertainty stems mostly from microwave dispersion. The largest contribution to the infidelity is spin decoherence, likely caused by the high density of defects in the crystal. Comparison with the testing data (as shown in FIG. 3 panels (b)-(d)) indicates that the model can slightly overestimate the impact of spin decoherence.

The table below shows contributions to the entangled state infidelity, according to some embodiments of the present disclosure. Marginal errors correspond to difference in simulated fidelity between the full model and one with individual sources of error eliminated. Systematic uncertainties are dominated by unknown dispersion of microwave pulses. Comparison with FIG. 3 panel (c) indicates that decoherence is probably overestimated. Errors due to systematic detuning and optimal interferometer phase can be highly correlated. Contribution of SiV contrast relates to residual infidelity when all other sources of error are removed from the model.

| Entanglement Error Source | Expected Marginal Error |
|---|---|
| Local Errors | |
| Decoherence T₂^{‡} | 10.7_{-0.8}^{+0.5}% |
| Microwave Pulse Errors | 1.5_{-1.3}^{+1.6}% |
| 2-photon events | 5.3 ± 0.2% |
| Heralded state error | |
| Systematic detuning^{†} | 7.5 ± 0.6% |
| Interferometer phase^{†} | 7.4 ± 0.9% |
| Carrier leakage | 1.6 ± 0.6% |
| Spectral diffusion | 0.3 ± 0.1% |
| SiV contrast* | 0.7% |
| Total Expected | 33.0_{-1.7}^{+1.4}% |
| Total Observed | 29.0_{-1.9}^{+1.8}% |

In some embodiments, by eliminating the state preparation and measurement errors, the model estimates the fidelity of the entanglement operation itself to be [symbol] _{corr}˜0.83. Assuming fine tuning of optical parameters, no microwave crosstalk, and the best previously observed spin coherence, an entanglement fidelity of [symbol] ˜0.95 can be achieved, still limited by residual spin decoherence. The entanglement rate is currently limited by low detection efficiency (η=0.04) and the use of a weak coherent state as heralding state. Together, this yielded a success probability of 6×10⁻⁴ per attempt and an entanglement rate of 0.9 Hz. Ultimately this protocol can reach 25% entanglement probability using single photon sources and critically coupled cavities. Using spin dependent phase flips in overcoupled cavities close to 50% entanglement probability can be reached, resulting in an entanglement rate of 50 kHz and providing an efficient mechanism for quantum networking.

Embodiments of the present disclosure describe a protocol to entangle quantum memories with far-detuned optical transitions, and demonstrate it using two SiVs with optical transition frequencies separated by 7.4 GHz. The protocol is inherently efficient and stable, as it relies on single photon interference in a common path. The approach can be extended both to spatially separated qubits as well as other spectrally inhomogeneous qubits. The current limits can be circumvented by using stable SiV centers in separate devices, and high entanglement fidelities are achievable with previously demonstrated parameters. This protocol can also result in very high entanglement rates with low loss modulators, integrated filters, and a single photon source instead of weak coherent pulses, opening the door for a broad range of new applications in quantum networking and quantum information processing.

### Example Implementations

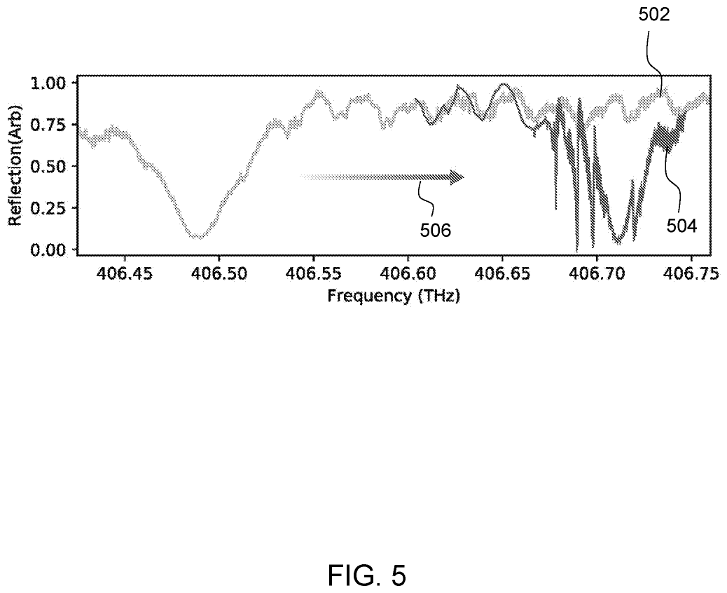

In some embodiments, all measurements can be performed in a dilution refrigerator (DR, BlueFors BF-LD250) with a base temperature of 20 mK. The DR can be equipped with a superconducting vector magnet (American Magnets Inc. 6-1-1 T), a home-built free-space wide-field microscope with a compact asphere objective (Newport 5722-B-H), piezo positioners (Attocube ANPx101 and ANPx311 series), and fiber and microwave (MW) feedthroughs. Tuning of the nanocavity resonance can be performed using a N₂ gas condensation technique. FIG. 5 shows the cavity spectrum before and after the cavity tuning, according to some embodiments of the present disclosure. The arrow 506 represent the tuning direction—from lower frequency to higher frequency. Curve 502 represents the cavity spectrum after the tuning while curve 504 represents the cavity spectrum before the tuning. The SiV-cavity system can be optically interrogated through the fiber network without any free-space optics. The operating temperature of the memory node during the entanglement measurements was T˜100-150 mK.

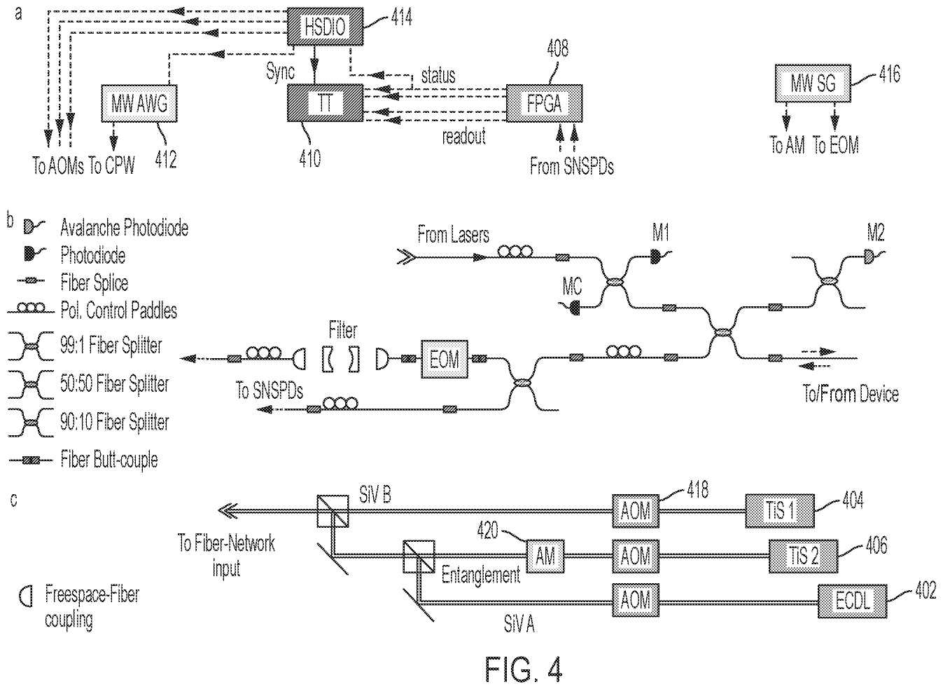

FIG. 4 shows detailed schematics of a control flow of a testing procedure, according to some embodiments of the present disclosure. As shown in panel (a), all signals can be recorded on a time-tagger 410 (TT, PicoQuant HydraHarp 400). A digital input-output device (National Instruments HSDIO) 414 controls the flow of the experiment by controlling the acousto-optical modulators (AOMs) 418 which gate the lasers, sending sync pulses to the time-tagger, and trigger the AWG (MW AWG) 412, which drives the microwave control pulses to the SiVs. All signals are recorded on a time-tagger (TT) 410. A second signal generator (MW SG) 416 produces a continuous microwave drive for the two EOMs used for the entanglement heralding. Panel (b) shows a fiber network used to deliver photons to and collect photons from the device, including elements for polarization control and diagnostic measurements of coupling efficiencies. A phase modulator electro-optic modulator (EOM_{ϕ}) mixes the heralding light from the two SiVs back to a central frequency which is selected by a filter cavity. Panel (c) shows preparation of optical fields. Laser fields for reading the state of the two SiVs and performing entanglement heralding are switched by double pass acousto-optic modulators (AOM) 418 and combined on non-polarizing beam splitters before being coupled into a fiber. The sidebands for the entanglement heralding light are generated by an amplitude modulator (EOM_{MZ}) 420.

The example apparatus for entanglement can include three parts: (1) a system for reading the state of the qubits, (2) a microwave setup for single qubit rotations, and (3) the entanglement heralding system. The readout of the qubits can be done with two lasers, an external cavity diode laser 402 (ECDL, Newport Velocity TLB-6711) and a Ti:Sapphire laser 404 (TiSaph, M Squared SolsTiS-2000-PSX-XF). These two lasers 402 and 404 can be tuned to the highest contrast frequencies for the two SiVs and sent to the nanophotonic cavity via fiber. Reflected photons can be collected via the same fiber and proceed via a directional coupler to a 50/50 beam splitter, one port of which is connected to superconducting nanowire single photon detectors (SNSPD, Photon Spot). Counts collected by this SNSPD can be used to determine the state of the SiVs. All detected photons are processed digitally on a field programmable gate array 408 (FPGA), and the arrival times of these photon are recorded on a time-tagger 410 (Hydarharp Time Tagger (TT)). At the end of the test, a 10 ps pulse from the readout path is reflected off the device, and photons are counted in order to determine the spin state depending on the threshold.

Rotations on the SiVs can be performed by driving magnetic dipole transitions of the SiV electron spins. Microwave signals can be produced by an arbitrary waveform generator 412 (Tektronix AWG70001a 50 GS/s) passed through a 11.313 GHz bandpass filter (Marki Microwave FB-1215) to remove digital switching noise and amplified by a microwave amplifier (MiniCircuits ZVA-183-S+). A DC block prevents any DC current flow into the test. The microwaves pass into the dilution refrigerator via stainless steel coaxial cables and are connected to a PCB that is wire-bonded to a coplanar microwave waveguide on the surface of the diamond.

The heralded entanglement setup consists of a laser, two electro optic modulators (EOMs) that generate and then combine the sidebands that interact with the SiVs and a tunable Fabry-Perot frequency filter. Light is generated by a second Ti:Sapphire laser 406 (M Squared SolsTiS-2000-PSX-XF) and passes through an amplitude modulator EOM (EOspace AZ-OK5-10-PFA-PFA-637) before being combined with light from the readout lasers. After reflecting off of the nanophotonic cavity, the herald light is collected at the other port of the 50/50 beam splitter (Evanescent Optics) and is launched onto a free space optics setup by a collimator (Thorlabs PAF-X-2B). The light passes through at telescope consisting of an achromat (LA1509B, focal length f=100 mm) and a f=30 mm achromat (AC127-030-B-ML) which mode matches it to the filter cavity. The filter cavity consists of two 99% reflective mirrors with a radius of curvature of 5 meters (LayerTec), separated by a 2 mm thick ring piezo (Thorlabs PA44LEW) for tuning. Light is coupled back into a fiber and guided to a second SNSPD by a symmetric set of lenses and collimators.

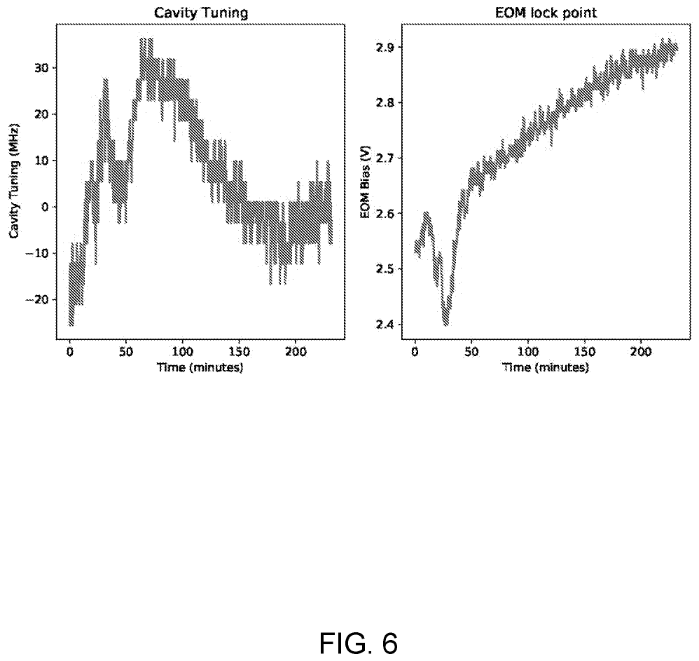

The free spectral range of the cavity is 75.11 GHZ, and the full width half maximum linewidth (FWHM) is 238 MHz, consistent with the mirror properties. Voltages amplified by a Thorlabs MDT693B can be applied to the piezo to tune the cavity at 1.83 GHz/V. After the filter cavity, the light is coupled back into a fiber by a symmetric set of lenses and collimators and sent directly to the heralding SNSPD. The end-to-end efficiency of the filter cavity is measured to be 9%. The filter cavity resonance is relatively stable over the course of the test, while the example optimal bias for suppressing the carrier in the amplitude modulator EOM can drift up to a quarter of V_{π}. FIG. 6 shows the EOM lock bias voltage and cavity tuning frequency as a function of time during a 4-hour test, according to some embodiments of the present disclosure. In some embodiments, the cavity FWHM is 238 MHz and the EOM V_{π} is 1.4 volts. In some embodiments, EOM lock bias can be controlled to prevent leakage of light through the EOM_{MZ} when it is in the off state. In some embodiments, the filter cavity tuning voltage can control what light is filtered and what light goes through, so it can be controlled if the central frequency is to be passed.

### Example Entanglement Sequence

In some embodiments, the sequence for entanglement consists of two parts, a pre-sequence to check the state of the SiVs, and an entanglement sequence. In some embodiments, SiV A can occasionally ionize, with the spectral feature disappearing entirely, and can be revived by applying light at 532 nm. In some embodiments, the spectral feature for SiV B does not disappear, but can hop between several metastable frequencies. The diffusion of SiV B happens faster when light at 737 nm is applied.

In some embodiments, the SiVs can be first initialized. For the initialization sequence, a laser (ECDL 402 for SiV A and TiSaph 404 for SiV B) can be applied for 10 us (302 in FIG. 3) and a π pulse (306 in FIG. 3) can be applied if recorded counts are higher than 7 in the case of SiV B or lower than 7 in the case of SiV A.

In some embodiments, if initialization fails for SiV A, a green light can be applied for 1 ms. In some embodiments, if initialization for SiV B fails, a 737 nm light can be applied for 1 ms. In some embodiments, this procedure does not deterministically put the SiVs in the correct state, so entanglement events can be post-selected where most of the surrounding unheralded trials ended with the correct readout.

Following the initialization sequence, 200 trials of the main entanglement procedure can be performed. In each trial, the readout from the preceding trial can be taken as the measurement for conditional initialization. This can be followed by the heralded entanglement sequence and finally the read out of the spin states.

### Echo Sequence and Mw Characterization

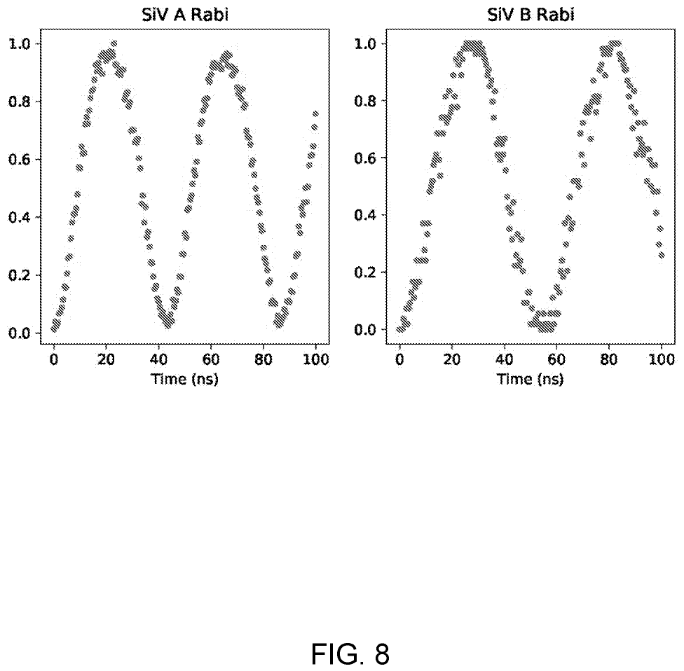

In some embodiments, the heralding pulses are applied in the middle of a series of microwave pulses that decouple the qubits from noise and put them in an equal superposition of two-qubit states. First a π/2 rotation (308 in FIG. 3) can be applied around the Y-axis to SiV A and then SiV B sequentially (11 and 14 ns). After that, the wait period can be 401 ns. During this window a 200 ns optical probe pulse (310 in FIG. 3) can be applied, starting roughly 100 ns after the π/2 rotations. Subsequently, a π rotation (312 in FIG. 3) can be applied around the X-axis on SiV A and then SiV B (22 and 28 ns, as shown in FIG. 8 which presents measurement results of Rabi driving on SiV A and SiV B according to some embodiments of the present disclosure). After 387 ns, a π/2 rotation (314 in FIG. 3) can be applied on SiV A around the negative Y-axis. This completes a Hahn echo on SiV A with τ=426 ns. Finally, after 25 ns and apply a π/2 rotation (314 in FIG. 3) on SiV B around the negative Y-axis, which completes a Hahn echo on SiV B with τ=437 ns. To read out in the Y basis (304 in FIG. 3), the final π/2 rotations can be applied around the X-axis instead and to read out in the Z basis the final rotations can be omitted entirely.

### T₂ Time

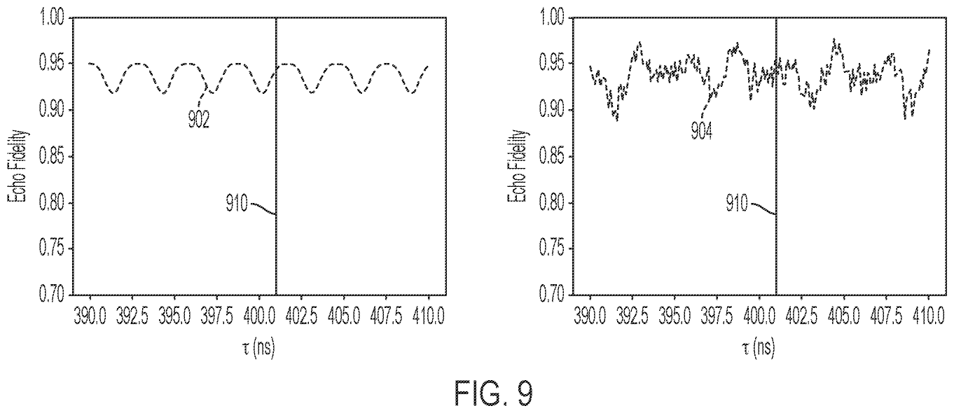

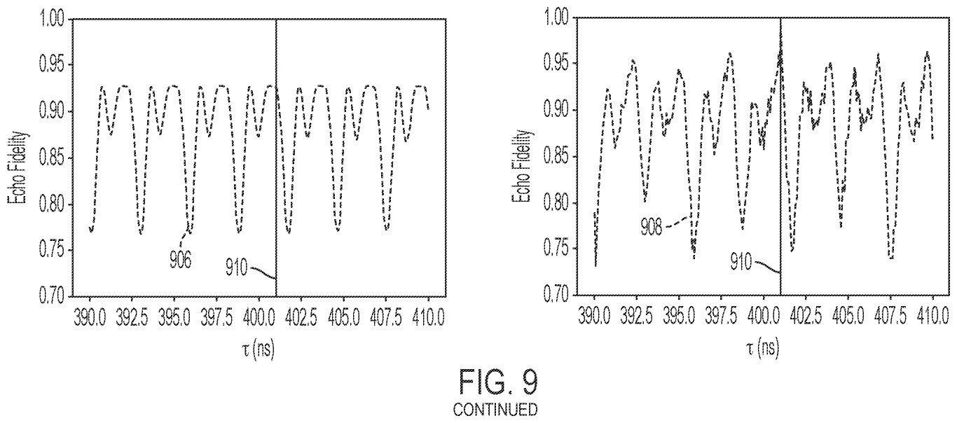

In some embodiments, to characterize the fidelity of our spin system, the simultaneous Hahn echo sequence can be performed on the spins, in the absence of any probe pulses. FIG. 9 shows measurement results of a simultaneous Hahn echo performed on SiV A (measurement date shown as 904 and the corresponding fit shown as 902) and SiV B (measurement date shown as 908 and the corresponding fit shown as 906), according to some embodiments of the present disclosure. Pulses are applied consecutively. Vertical line 910 indicates value of τ used for the entanglement procedure. Both echo curves have collapses and revivals with the echo curve on SiV A revealing a beating pattern between two frequencies. In some embodiments, these frequencies (342 MHz and 686 MHz for SiV A) can be higher than expected Larmour frequencies of nuclear spins in our field (≈5 KG) while being much lower than the expected Larmour frequencies of other SiV spins. However, these beats could be aliased by the Nyquist frequency of our sweep (10 GHz) which would mean the true frequencies are 10.342 GHz and 10.686 GHz. These frequencies are plausible for an SiV electron spin with moderate hyperfine interaction with SiV A.

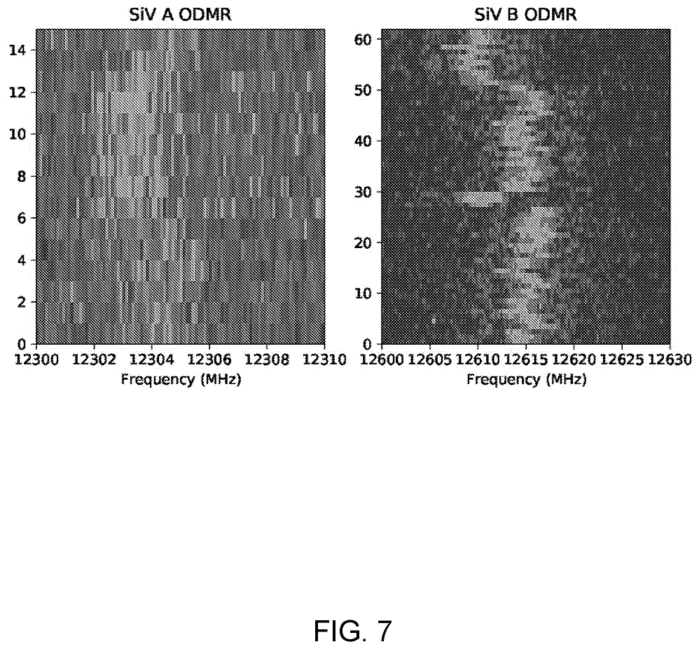

In some embodiments, τ can be 401 ns to minimize coupling to this spin. At this value, the average fidelity is 0.96 for SiV A and 0.95 for SiV B. However, over the course of the procedure, the diffusion of the SiV A qubit frequency can be observed (as shown in FIG. 7), on a timescale suggestive of changes in gyromagnetic ratio caused by strain, rather than magnetic fluctuations of a ¹³C bath. These gyromagnetic ratio changes would have changed the hyperfine interaction with the closely coupled spin. Decoherence caused by changes in the hyperfine coupling could explain both the fluctuation in observed fidelity of the echo sequence during the entanglement procedure, as well as its overall smaller value.

### Example Bounds on Magnetic Dipole Interaction

In some embodiments, given the strongly coupled spins implied by the dual Hahn Echo sequence, tests can be performed to rule out magnetic dipole interactions between SiV A and B. A dual electron-electron resonance (DEER) sequence can be used to isolate the coupling between the SiVs from any environmental effects.

The DEER sequence can consist of a Hahn Echo sequence applied to the target spin where the last π/2 pulse has a Y rather than X phase and a x pulse applied to the control spin in the middle of the echo sequence. Initializing the control spin in the up vs down state before the sequence will produce oscillating fields with different signs which the target spin will be sensitive to in the event of nonzero magnetic coupling.

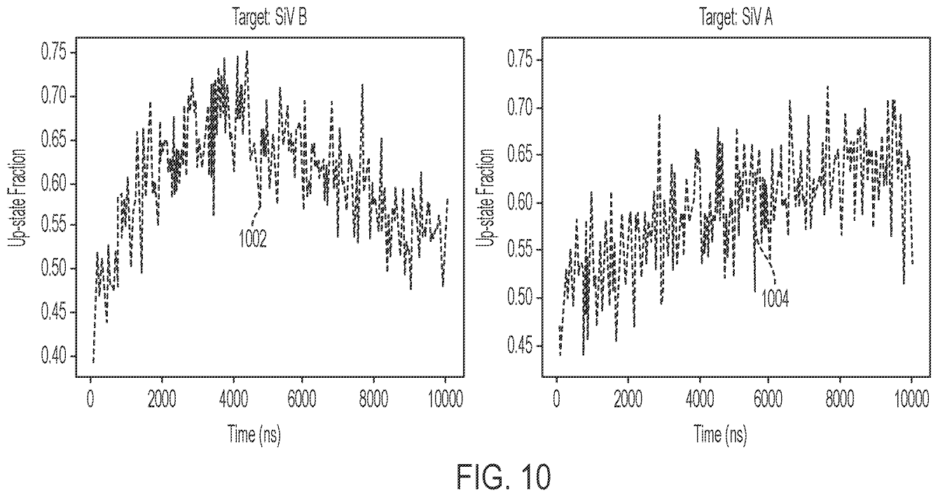

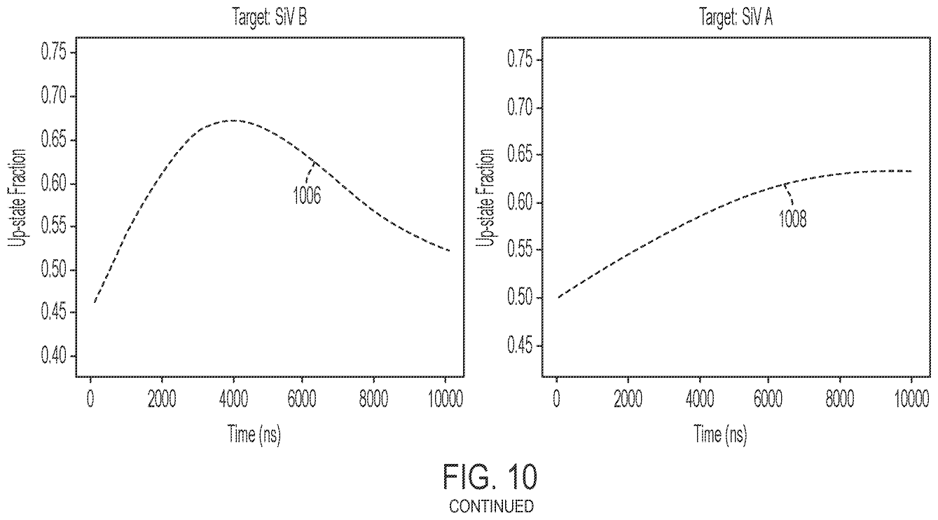

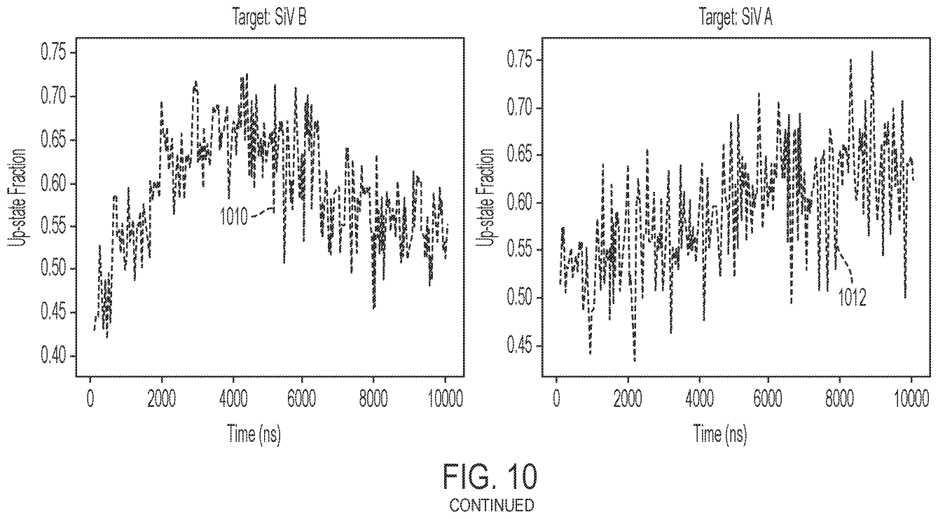

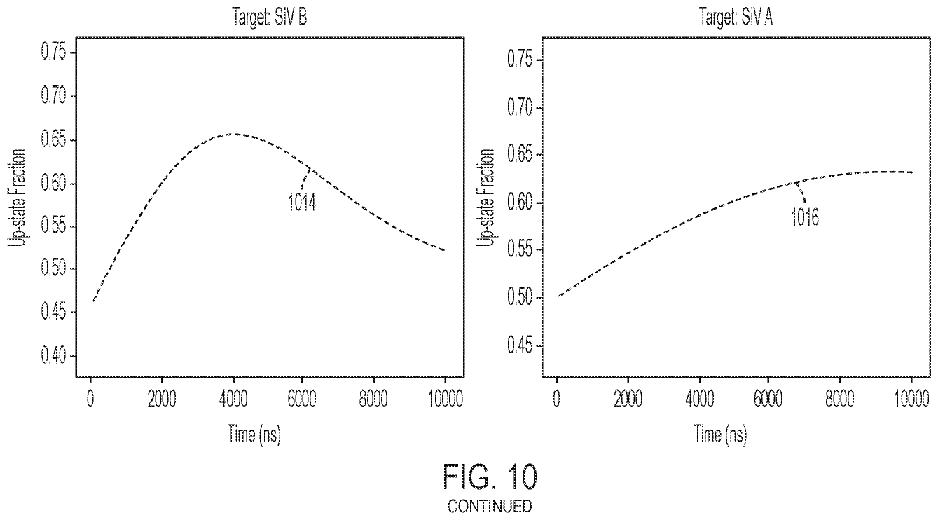

FIG. 10 shows measurement results of a DEER sequences performed between SiV A and B, according to some embodiments of the present disclosure. Fits are a sinusoid multiplied by a decaying T₂ envelope. Curves 1002 and 1004 represent measurement results of control spin down for SiV B and SiV A, respectively. Curves 1006 and 1008 are corresponding fits. Curves 1010 and 1012 represent measurement results of control spin up for SiV B and SiV A, respectively. Curves 1014 and 1016 are corresponding fits. Common mode sinusoid behavior is from drive-qubit detuning. In some embodiments, DEER sequences can be performed with SiV A and B as both target and control spin, and find the difference between the results with the control spin up vs down implies a coupling of at most 6±2×102 Hz between the two SiVs, which would produce negligible interaction during our 800 ns long entanglement sequence.

### Example Coupling Efficiency Calibration

In some embodiments, the fiber-device coupling efficiency can be measured with two independent tests. First, a broadband light from a supercontinuum laser through the fiber can be applied and the reflected intensity can be measured. By comparing the reflection to a calibration value obtained with a retro-reflector spliced to the end of the fiber, we calculate an 86% fiber-device coupling efficiency.

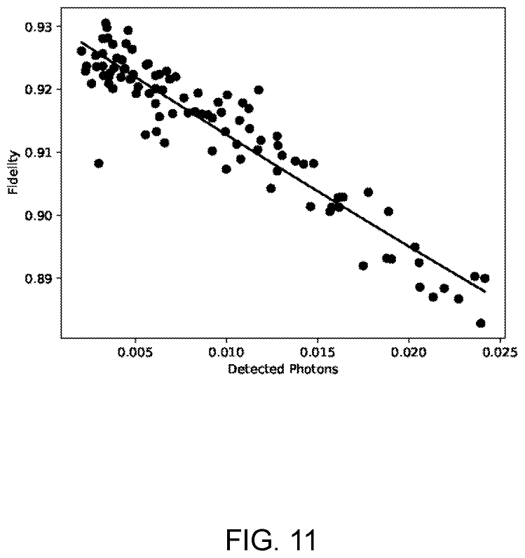

FIG. 11 shows fidelity of a Hahn echo on SiV B as a function of the number of photons detected by the readout SNSPD, according to some embodiments of the present disclosure. In some embodiments, a test with reflected light from the device at the frequency of greatest contrast for SiV B during one window of a Hahn Echo sequence on SiV B can be performed. In some embodiments, every photon that scatters from the device has a 50% chance of flipping the electron to the wrong state. In some embodiments, roughly half of the photons incident on the device are reflected back. Of those, a fraction denoted by η_{wg} make it to the 50/50 beamsplitter. Extrapolating from the decrease in fidelity per detected photon, it can be estimated that η_{wg}=84±3% using this method.

The transmission of the filter cavity η_{cav}=0.09 can be measured with photodiode measurements during cavity alignment and by comparing the counts on the readout and heralding SNSPDs when light at the filter cavity frequency is reflected off of the nanocavity.

At the drive power we operate at, 31% of incident power at the phase EOM is transferred to each sideband. Constructive interference doubles this power in the example interferometer implementation. Given a heralding rate of 6×10⁻⁴ per entangling attempt, and the fact that the two SiVs are prepared in an equal mixture of all four Bell states, it can be calculated that the mean photon number at the cavity is [symbol] n [symbol] =0.106, which translates to a 5.3% decoherence due to two-photon events.

### Cooperativity

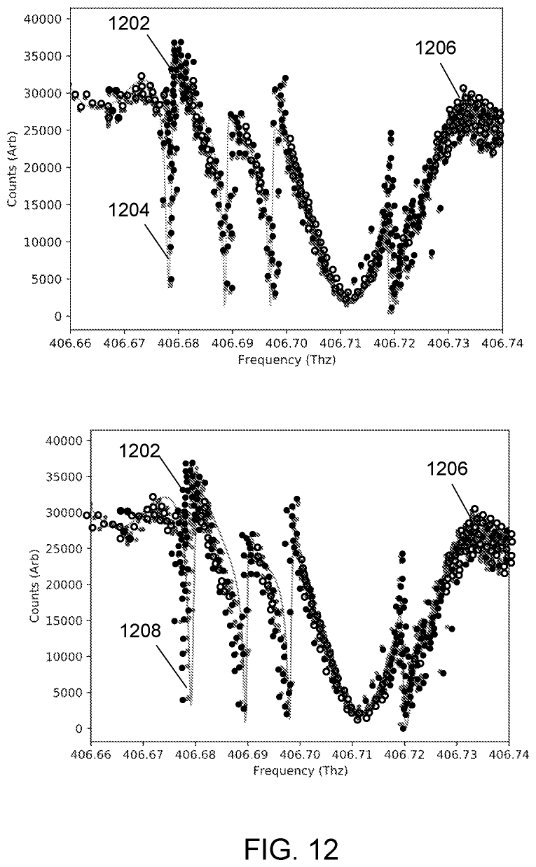

FIG. 12 shows ECDL scan of the SiV-cavity system (1202: |↑ [symbol] , 1206: |↓ [symbol] ) and fit for the |↓ [symbol] 1208 and |↑ [symbol] 1204 states, assuming a sinusoidal wavelength-dependent modulation of laser intensity, according to some embodiments of the present disclosure. Points near SiVs are excluded, because SiVs are not initialized for this scan, as well as outliers. In some embodiments, to obtain the cavity parameters, as well as the coupling strength of the SiVs to the cavity field, several laser scans of the cQED system can be performed. The laser frequency across the cavity can be initially scanned without initializing the SiVs. This data can be fitted with a model including several cavity coupled SiVs and a sinusoidal modulation of the input power: The amplitude reflectivity of this system is

$$R ( {ω}_{l} , {ω}_{k} ) = 1 - \frac{2 {κ}_{ω}}{i {Δ}_{c} + {κ}_{tot} + {Σ}_{k} \frac{{g}_{k}^{2}}{i {Δ}_{a , k} + {γ}_{k}}} , \qquad ( S1 )$$

where Δc=ωₗ−ω_{c} represent the detuning of the laser (at frequency ωₗ from cavity resonance (at frequency ω_{c}). Similarly, for each SiV, labeled by index k, Δ_{a,k}=ωₗ−ω_{c} is the detuning of the laser from the resonance of SiV k (at frequency ωₖ). The total cavity loss rate κₜₒₜ=κ_{ω}+κₗ is the sum of the scattering rate KI and leakage into the waveguide (κ_{ω}). After a rough fit of all parameters, the data points close to the SiVs are excluded, as quantum jumps of the spin states result in noisy data close to their resonances. The remaining spectrum is fitted with an additional weight on the center of the cavity, thereby ensuring that the ratio of loss to waveguide coupling κₗ/κ_{ω} is correct, as this has the strongest influence on the final model. In some embodiments, κₗ/κ_{ω} due to the fact that several SiV resonance dip below the lowest point of the cavity resonance.

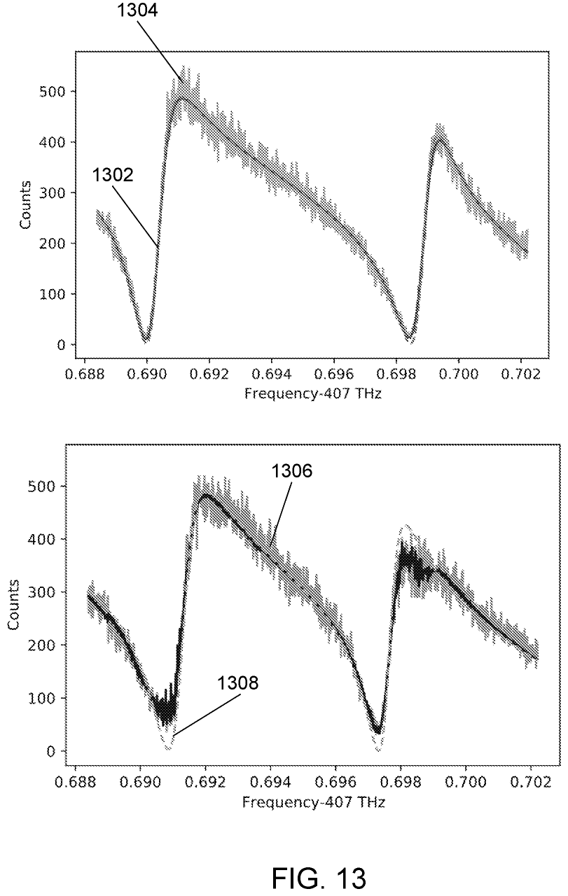

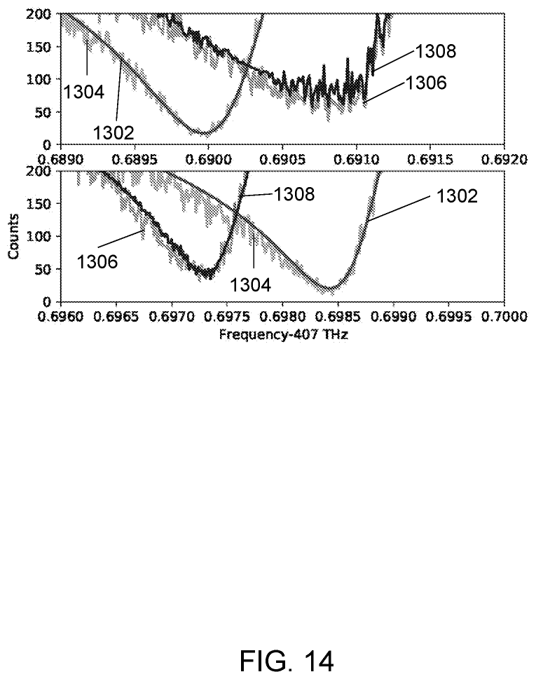

FIG. 13 shows measurement results from laser scan of the SiV-cavity system and fit taking into account spectral diffusion and state of SiV after initialization attempt, according to some embodiments of the present disclosure. Curves 1304 and 1306 represent the SiV-cavity system before an initialization attempt (1304: |↑↓ [symbol] , 1306: |↓↑ [symbol] ). Curves 1302 and 1308 represent the SiV-cavity system after an initialization attempt (1302: |↑↓), 1308: |↓↑ [symbol] ). Dashed lines represent expected spectrum with ideal initialization and no optical diffusion. FIG. 14 shows details of fits of laser scan of the SiV-cavity system in FIG. 13, according to some embodiments of the present disclosure. Precise matching of the dips in the spectrum is important, as the residual reflection off the |↓ [symbol] state dominates the interference pattern in the phase scan of the interferometer. Noise on the fit of the |↓↑ [symbol] state (1308) is a result of the imperfect initialization fidelity measured at each laser detuning. Contrast of the |↑↓ [symbol] state (1302) appears superior due to better initialization.

In some embodiments, a narrow scan can be performed across the frequencies of SiV A and B, initializing them in the |↑↓ [symbol] respectively |↓↑ [symbol] state. By measuring the spin state again after the laser scan the initialization fidelity of each spin can be extracted during the laser scan. In some embodiments, the same model S1 can be used to fit the spectra, this time adding optical diffusion of the optical transition frequency of the SiVs with a Gaussian probability distribution, and taking into account the uncertainty in the data due to shot noise. The relevant cQED parameters from this fit are detailed in the table below. It can be found that the resulting cooperativity

$${C}_{k} = \frac{{g}_{k}^{2}}{{κ}_{tot} {γ}_{k}}$$

for both SiVs is robust against possible sources of systematic uncertainty, such as offset in the broad spectrum (FIG. S9) beyond the calibrated background counts.

TABLE S1
Relevant parameters of the cavity QED system.

| Parameter | SiV A | SiV B | Cavity |
|---|---|---|---|
| resonance | ω_{A, ↑} = 2π · 406.692 THz | ω_{B, ↑} = 2π · 406.699 THz | ω_{c} = 2π · 406.706 THz |
| detuning | Δ_{A} = 2π · 14.6 GHz | Δ_{B} = 2π · 7.2 GHz | |
| optical line splitting | ω_{A, ↑} − ω_{B, ↓} = | ω_{B, ↑} − ω_{B, ↓} = | |
| | 2π · 0.95 GHz | 2π · 1.23 GHz | |
| natural linewidth | γ_{A} = 2π · 80 MHz | γ_{A} = 2π · 97 MHz | κₜₒₜ = 2π · 14.5 GHz |
| | | | κ_{ω} = 2π · 9.0 GHz |
| | | | κᵢ = 2π · 5.4 GHz |
| spectral diffusion | σ_{A} = 2π · 58 MHz | σ_{B} = 2π · 113 MHz | |
| coupling strength | g_{A} = 2π · 4.1 GHz | g_{B} = 2π · 2.9 GHz | |
| cooperativity | C_{A} = 6.1 | C_{B} = 14.4 | |
| (instantaneous) | | | |
| cooperativity | C_{A} = 4.0 | C_{B} = 11.7 | |
| (averaged) | | | |

### Example Readout Fidelity and Cyclicity

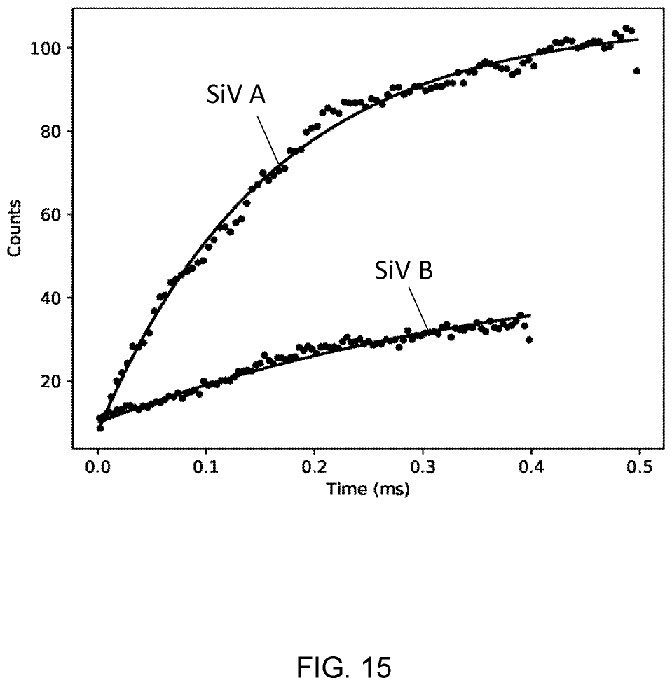

FIG. 15 shows average counts under laser illumination as a function of time for SiV A and B after being initialized in the spin down (non-reflective) state, according to some embodiments of the present disclosure. In some embodiments, to find the branching ratios for the optical transitions, SiV A or B can be initialized in the non-reflecting state and then apply the readout laser until the averaged reflected counts converge to halfway in between the up and down state reflectivities. The time constant of this curve can be used with the measured count rate in the reflective state at the same laser power to calculate the mean number of reflected photons necessary to flip each spin. In some embodiments, it can be found that rₐ=3.8+0.1×103 and r_{b}=9.2±1.3×103.

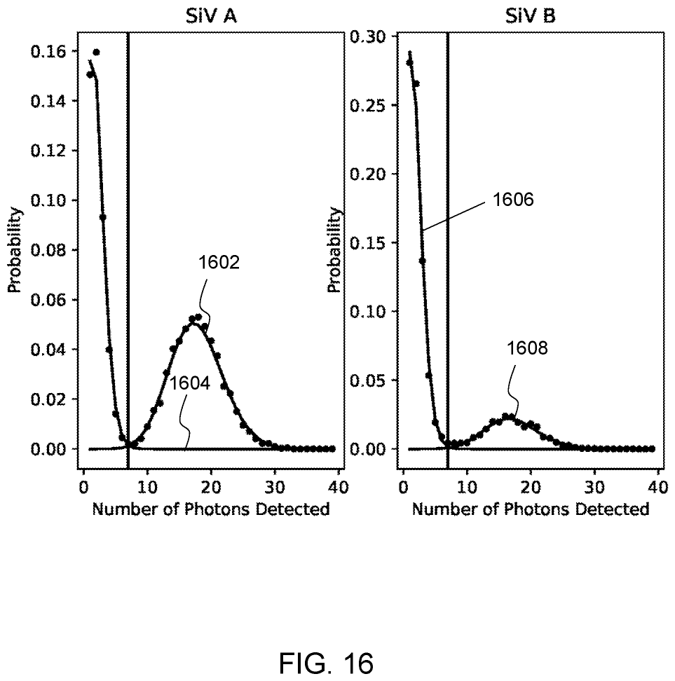

FIG. 16 shows histograms of photons received after a 10 us readout pulse following a pi-half rotation on each SiV, fit with two Poisson distributions with mean values 1.9 and 17.7 for SiV A low and high and 1.7 and 17.0 for SiV B low and high, respectively, according to some embodiments of the present disclosure. Curves 1602 and 1604 represent Poisson distribution fits for two states of SiV A. Curves 1606 and 1608 represent Poisson distribution fits for two states of SiV B. In some embodiments, lasers can be applied for a 10 us window to each SiV and look at the histogram of received counts. The histogram can then be fitted with two Poisson distributions and the probability of the up state being misidentified as the down state or vice versa can be calculated. It can be found that the odds of correctly identifying the state are 99.89% for SiV A and 99.87% for SiV B.

In some embodiments, the readout and initialization fidelity can be evaluated by initializing both spins in the down state approximately 30,000 times and then reading the state of both spins. In some embodiments, it can be found that the fidelity [symbol] _{rA}=99.839±0.006% and [symbol] _{rB}=99.910±0.0045% observed during these runs is in good agreement with the fidelity predicted by the branching ratio and readout histograms.

### Example Role of Siv-Cavity Detuning in Contrast

In some embodiments, the CQED system is able to achieve high spin-dependent contrast for a range of atom-cavity detunings with only moderate cooperativities. To see why, the reflected field from the cavity can be expressed by:

$$R = 1 - \frac{2 {κ}_{ω}}{i {Δ}_{c} + {κ}_{tot} + \frac{{g}^{2}}{i {Δ}_{a} + γ}} ,$$

where Δ_{a,c}=ω−ω_{a,c} represent the detuning from the SiV and cavity, respectively and the total cavity loss rate is a product of the scattering loss and leakage into the waveguide

$$κ = {κ}_{ω} + {κ}_{l} .$$

In some embodiments, for the SiV feature to dip to zero reflectively, the denominator must meet the condition

$$i {Δ}_{c} + {κ}_{tot} + \frac{{g}^{2}}{i {Δ}_{a} + γ} = 2 {κ}_{ω} ,$$

which is satisfied when

$${Δ}_{a} = \sqrt{\frac{{g}^{2} γ}{2 {κ}_{ω} - κ} - {γ}^{2}}$$

$$and$$

$${Δ}_{c} = \frac{2 {κ}_{ω} - κ}{γ} \sqrt{\frac{{g}^{2} γ}{2 {κ}_{ω} - κ} - {γ}^{2}} .$$

This implies that the optimal SiV-cavity detuning can be

$$Δ = {Δ}_{c} - {Δ}_{a} = ( \frac{2 {κ}_{ω} - κ}{γ} - ) \sqrt{\frac{{g}^{2} γ}{2 {κ}_{ω} - κ} - {γ}^{2}} .$$

Assuming that γ<<g, κ_{ω}+κₗ:

$$Δ = g \sqrt{\frac{{κ}_{ω} - {κ}_{l}}{γ}}$$

To see how sensitive the contrast is to changes in the SiV-cavity tuning, Δₐ can be held fixed and Δ_{c} can vary. Then for small deviations (δc) around the detuning that would lead to a reflection dip to zero, it can be shown that:

$$R ( {δ}_{c} ) = 1 - \frac{2 {κ}_{ω}}{2 {κ}_{ω} + i {δ}_{c}}$$

If the detuning Δ_{c}>κ, then the reflection near the SiV dip will approach 1. Thus, to maintain 1:10 contrast of the feature

$$\vert {δ}_{c} \vert \leq \frac{2}{3} {κ}_{ω} .$$

In practice, this means that we can maintain 90% spin-dependent contrast for a given SiV over a range of atom-cavity detunings comparable to the cavity linewidth.

### Example Theoretical Model of the System

Without being bound by theory, in some embodiments, the system can be modeled using the cavity QED parameters described in Tab. S1. The systems can be probed by the two laser sidebands at the frequencies ω_{laser,A}=406.6910 GHz and ω_{laser,B}=406.6984 GHz. The amplitude of the photonic wavefunction in transmission of the cavity is

$$T ( {ω}_{A} , {ω}_{B} ) ∝ {c}_{carrier} R ( {ω}_{carrier} , {ω}_{A} , {ω}_{B} ) {e}^{i {ϕ}_{c}} + {c}_{sideband} R ( {ω}_{sbA} , {ω}_{A} , {ω}_{B} ) {e}^{- i Δ ϕ / 2} + {c}_{sideband} R ( {ω}_{sbB} , {ω}_{A} , {ω}_{B} ) {e}^{i Δ ϕ / 2} , \qquad ( S2 )$$

with the cavity reflection coefficient R defined in equation (S1), the carrier frequency ω_{carrier}=(ω_{sbA}+ω_{sbB})/2, the sideband frequencies ω_{sbA} and ω_{sbB}, and the spin-dependent SiV resonances ω_{A}∈{ω_{A,↑}, ω_{A,↓}} and ω_{B}∈{ω_{B,↑}, ω_{B,↓}}. The coefficients for the carrier leakage c_{carrier}=0.08 and the sideband efficiency c_{sideband}=0.38 can bedetermined by characterizing the EOMs. The phase of the carrier ϕ_{c} is in the ideal case close to 0, but can vary due to dispersion and drifts in the lock point of the intensity modulator EOM_{mz}, with example values possible in the range of ϕ_{c}∈[−π/2, π/2]. For the phase scan, ϕ_{c} can be set to be 0, as EOM_{mz} was locked stringently, whereas it can be left as a free parameter to test the correlation, where it was locked only occasionally in some example tests. While the carrier phase only has a minor influence on the predicted fidelity, the YY correlations and the XX correlations, strongly influences the balance between the |↑↓ [symbol] _{AB} and |↓↑ [symbol] _{AB} state. The carrier phase can be chosen to match this balance, finding ϕ_{c}=0.398π.

In some embodiments, the relative phase of the sidebands Δϕ=2ϕμ can be controlled by the relative phase of the microwave signals ϕμ driving the two EOMs. In some embodiments, instead of directly applying a phase shift, the differential (optical) path length ΔL between the optical and the microwave path can be made use of and the relative phase ϕμ=ΩΔL/c can be controlled by fine tuning the microwave frequency Ω, with the speed of light c. As the free spectral range of the microwave-optical interferometer c/ΔL˜4.7 MHz is far below the size of the spectral features, this does not adversely affect the performance of the protocol.

In some embodiments, a spin state |ψᵢₙ [symbol] _{AB}∝α_{↑↑}|↑↑ [symbol] _{AB}+α_{↑↓}|↑↓ [symbol] _{AB}+α_{↓↑}|↓↑ [symbol] _{AB}+α_{↓↓}|↓↓ [symbol] _{AB} upon detection of a heralding photon in transmission of the cavity can be projected into

$${{{{\vert {ψ}_{out} 〉 ∝ T ( {ω}_{A , ↑} , {ω}_{B , ↑} ) {α}_{↑ ↑} \vert ↑ ↑ 〉}_{AB} + T ( {ω}_{A , ↑} , {ω}_{B , ↓} ) {α}_{↑ ↓} \vert ↑ ↓ 〉}_{AB} + T ( {ω}_{A , ↓} , {ω}_{B , ↑} ) {α}_{↓ ↑} \vert ↓ ↑ 〉}_{AB} + T ( {ω}_{A , ↓} , {ω}_{B , ↓} ) {α}_{↓ ↓} \vert ↓ ↓ 〉}_{AB} \qquad ( S3 )$$

To complete the model, non-ideal local qubit operations can be properly account for, resulting from non-ideal pulse parameters, off-resonant driving and decoherence.

In some embodiments, these parameters can be extracted from spin measurements performed during the example correlation test when no heralding photon was detected. As the predicted fidelity is most sensitive to the decoherence, YY and ZZ basis measurements can be alternated with an XX basis measurement, which in the unheralded case is a simple Hahn-Echo test to measure the decoherence of the spins during the sequence. This furthermore allows for post-selecting the heralded data based on the fidelity of the N=500 XX measurements closest to the heralding event to exclude instances when an SiV was ionized, or the Zeeman splitting ZA or ZB was far off the assumed value. Furthermore, this can ensure that SiV B was effectively decoupled from the dark spin observed in FIG. 9. In some embodiments, data with a Hahn Echo fidelity better than 1− [symbol] _{HE,A}≤0.17 and 1− [symbol] _{HE,B}≤0.15 can be included. Extreme outliers in the N=500 YY or ZZ measurements closes to the heralding event can be further excluded. This may not significantly influence the fidelity measurement but improves the convergence of the fitted microwave errors, improving the predictive power of our model.

While fitting the ZZ distributions allows for constructing a realistic model of the pulse amplitude, detuning and spectral diffusion of the Zeeman splitting, there remain two undetermined parameters, the angle error of the readout basis, and the relative phase of the two microwave tones. The angle error originates from jitters in the AWG timing and can be estimated from the unheralded YY correlation data to be on average of the order of 0.5 to 0.10 radians. The overestimation of the decoherence from the average Y angle error corresponds to an increase in expected fidelity by 0.003, which is treated as a systematic uncertainty.

In some embodiments, the relative phase between the pulses addressing SiV A and SiV B can be well defined at the source, but can be different at the device due to dispersion in the microwave cables to the sample. This is exacerbated by resonances in the cryogenic coaxial cables observed in the system. In some embodiments, the microwave dispersion cannot be measured at cryogenic temperatures, so no reliable information about the actual relative phase of the two frequencies at the sample can be obtained. the system can therefore be simulated for a set of 24 equally distributed microwave phases between 0 and 2π. The cited predicted values of the model are averaged over all microwave phases, and the associated systematic uncertainty describes the standard deviation of the predicted values for all sampled microwave phases.

In some embodiments, this model is not uniquely defined due to the data it is based on and there are clear deviations between the measured data and the prediction by the model. These deviations however do not substantially influence the estimation of the fidelity.

### Predicted Fidelity and Error Budget

Without being bound by theory, in some embodiments, the example model predicts fidelities in the range of 0.643≤ [symbol] ≤0.695 with an average value of [symbol] [symbol] [symbol] =0.670 and an uncertainty due to the angle of the read axis during the calibration of the spin decoherence of ₋₀^{+0.003}. This is consistent with the measured fidelity of [symbol] =0.710_{-0.018}^{+0.019}. In some embodiments, the relative microwave phase can result in the highest predicted fidelity, and therefore the best overlap with the measured value coincides with the highest consistency between the estimate of the read angle error of SiV A and SiV B.

To understand the leading contributions the state preparation error, the individual error sources from the model can be eliminated and the resulting fidelity can be compared with the predicted fidelity of the complete model. In some embodiments, the marginal error contribution ε_{source}= [symbol] − [symbol] for the dominant sources can be the average value [symbol] ε_{source} [symbol] with the systematic error relating to uncertainties originating from the microwave dispersion, the exact probability of multi-photon states at the cavity, and the systematic uncertainty in the calibrated decoherence due to the estimated read angle error.

In some embodiments, the residual reflection from the |↓↓ [symbol] _{AB} state can be a key contributor to the heralded state infidelity (note that the ZZ readout of in FIG. 3 panel (e) is inverted due to the dynamical decoupling sequence). This primarily relates to the fact that SiV A was initialized in the |↑ [symbol] _{A} state, rendering the preselection of low optical spectral diffusion ineffective. As a consequence, the sideband frequency ω_{sbA} did not probe the spectrum at its maximum contrast point, leading to substantial residual reflection from the |↓ [symbol] _{A} state. This can in principle be compensated by adjusting the interferometer phase to cancel this contribution, which would correspond to mod2π (ϕμ)˜2.7 radians. This was however not obvious from the phase scan in FIG. 2 panel (b), as in that measurement SiV was in fact initialized in the |↓_{A} state, inadvertently resulting in a different optical detuning of ω_{sbA} from the value in the correlation test. Thus, by the optimal phase from the interferometer phase scan in FIG. 2 panel (a), resulted in a sub-optimal phase setting for the actual correlation measurements. Consequently, choosing an optimal interferometer phase can have the same effect as an optimal sideband frequency, for the marginal error, namely, to suppress the reflection from the |↓↓ [symbol] _{AB} state.

In some embodiments, the carrier leakage can be further reduced using coherent canceling in a Sagnac configuration, reducing the total marginal error budget of the heralded state errors to ˜1%, related to the parameters of the cavity QED system.

### Extension to Spatially Separated Qubits

In some embodiments, the scheme can be extended to two or more qubits in spatially separated cavities. By arranging two cavities in series, two or more qubits in spatially separated cavities can be interrogated by the same heralding laser using optical circulators.

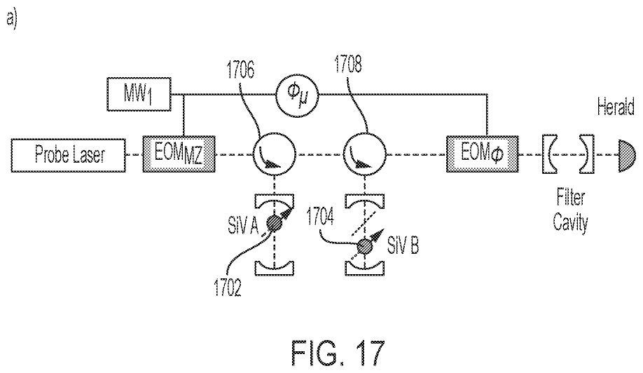

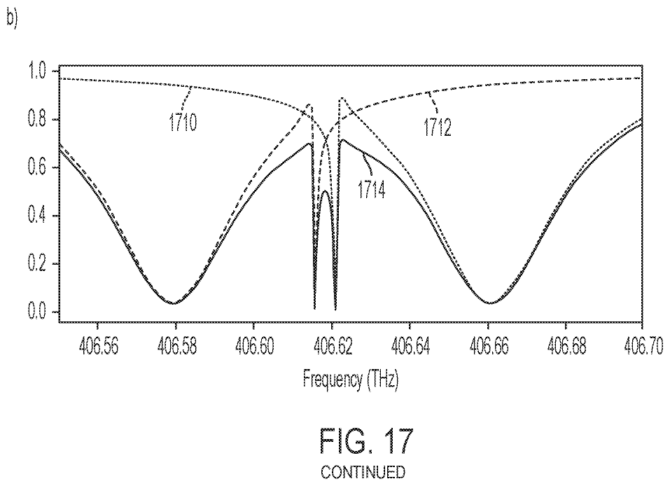

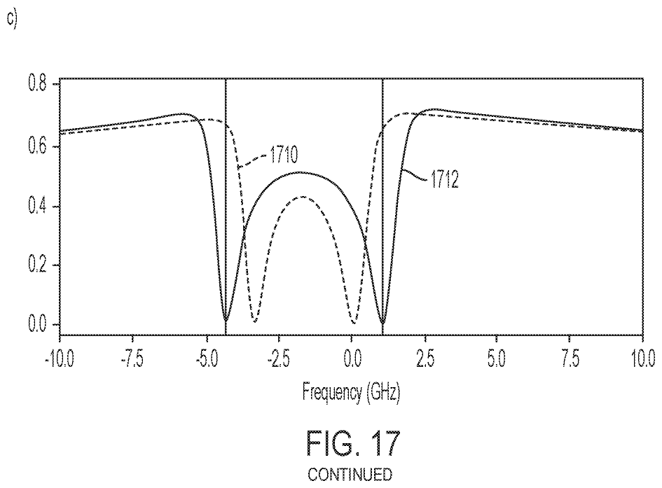

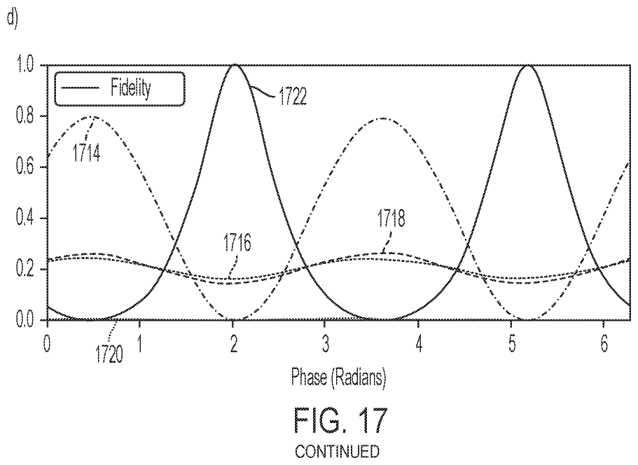

FIG. 17 shows schematics for entangling qubits in spatially separated cavities, according to some embodiments of the present disclosure. Panel a) shows that the two cavities 1702 and 1704 are interrogated by the heralding light in series by using a pair of optical circulators 1706 and 1708. Panel b) shows the combined spectrum 1714 of the two cavities and individual spectra 1710 and 1712. By placing the cavities on opposite sides of their respective emitters, the frequency used to interrogate SiV B is reflected from the cavity containing SiV A without a spin dependent shift and vice-versa. Panel c) shows a magnified copy of the spectrum near the SiVs showing the spin-dependent reflections. Panel d) shows the heralding reflection (y-axis) as a function of phase (x-axis) for all four spin-states (1714, 1716, 1718, and 1720) and the achieved entanglement fidelity 1722 after detecting a heralding photon.

In some embodiments, the cavity-emitter detuning can be independently adjusted for each qubit, allowing for both high contrast and maximum bandwidth for the qubit reflection features. In some embodiments, the maximum heralding bandwidth is then limited by the Purcell broadening of the qubit reflection feature. In some embodiments, this scheme can allow the entanglement of more than two qubits by driving the final “beam-combining” phase EOM with multiple tones to shift all the heralding frequencies to one frequency, erasing path information. In some embodiments, this can decrease the heralding efficiency by 2-n as at least one sideband is lost per heralding frequency. This loss of efficiency can be perhaps mitigated with more sophisticated drive schemes. In some embodiments, this serial arrangement of cavities can allow for retaining the properties of 1-photon heralding and robustness to path length fluctuations, even for multiple spatially separated qubits. In some embodiments, this setup can mitigate microwave crosstalk as microwave rotations can address just one qubit.

While the invention has been particularly shown and described with reference to specific preferred embodiments, it should be understood by those skilled in the art that various changes in form and detail can be made therein without departing from the spirit and scope of the invention as defined by the appended claims. Those skilled in the art would understand that particular measurements achieved during tests of the invention and numbers obtained during simulations of the invention do not limit the scope of the invention in any way, unless otherwise noted. Likewise, the theoretical explanations provided in the present disclosure to describe various aspects of the invention are merely examples and do not limit the scope of the invention, unless otherwise noted.

1. A system comprising:
a first qubit having an optical transition at a first qubit frequency;
a second qubit having an optical transition at a second qubit frequency;
a light source producing a first light beam having at least a first frequency; and
an interferometer configured to convert the first light beam into at least one second light beam, to provide the at least one second light beam to the first qubit and the second qubit, and to provide an output light signal, the interferometer comprising:
a first optical modulator that converts the first light beam into the at least one second light beam, the at least one second light beam having at least a second frequency and at least a third frequency, the second frequency substantially matching the first qubit frequency and the third frequency substantially matching the second qubit frequency, and
a second optical modulator that produces the output light signal from the at least one second light beam, the output light signal having at least a fourth frequency.

2. The system of claim 1, wherein one or more of the first qubit or the second qubit comprises a silicon vacancy (SiV) qubit.

3. The system of claim 1, wherein one or more of the first qubit or the second qubit comprise a nitrogen vacancy (NV) qubit.

4. The system of claim 1, wherein one or more of the first qubit or the second qubit comprise a rare earth ion qubit.

5. The system of claim 1, wherein one or more of the first qubit or the second qubit comprise a quantum dot.

6. The system of claim 1, wherein one or more of the first qubit or the second qubit comprise a silicon carbide (SiC) defect.

7. The system of claim 1, wherein one or more of the first qubit or the second qubit comprise an optically active defect in a silicon crystal.

8. The system of any one of the preceding claims, wherein the light source comprises a laser.

9. The system of any one of the preceding claims, wherein one or more of the first optical modulator comprise an electro-optic modulator or an acousto-optic modulator.

10. The system of any one of the preceding claims, wherein one or more of the second optical modulator comprise an electro-optic modulator or an acousto-optic modulator.

11. The system of any one of the preceding claims, further comprising a photon detector configured to detect the output light signal.

12. The system of claim 11, wherein the photon detector comprises a superconducting nanowire single photon detector.

13. The system of claim 11, wherein the output light signal further comprises at least one light beam having at least a fifth frequency and the system further comprises an optical filter configured to remove the at least one light beam of at least the fifth frequency before the output light signal is detected by the photon detector.

14. The system of any one of the preceding claims, further comprising a microwave source configured to generate microwaves at one or more of the first qubit frequency or the second qubit frequency.

15. The system of any one of the preceding claims, wherein the first qubit reflects or transmits light based on the frequency of the light and a quantum state of the first qubit, and wherein the second qubit reflects or transmits light based on the frequency of the light and a quantum state of the second qubit.

16. The system of claim 15, wherein the second optical modulator shifts a frequency of the light that is transmitted from the first qubit and the second qubit and wherein the second optical modulator does not receive light that is reflected from the first qubit and the second qubit.

17. The system of claim 15, wherein the second optical modulator shifts a frequency of the light that is reflected from the first qubit and the second qubit and wherein the second optical modulator does not receive light that is transmitted from the first qubit and the second qubit.

18. The system of claim 16, wherein the output light signal is dependent on the quantum state of the first qubit and the quantum state of the second qubit such that:
when the first qubit and the second qubit are in the same quantum state, either light of the second frequency and light of the third frequency are reflected by the first qubit and the second qubit such that there is no light for the second optical modulator to produce the output light signal or light of the second frequency and light of the third frequency destructively interfere after being modulated by the second optical modulator; and
when the first qubit and the second qubit are in different quantum states, either light of the second frequency or light of the third frequency is transmitted to the second optical modulator such that the at least one second light beam is converted into the output light signal.

19. The system of claim 18, wherein the presence of the output light signal indicates that the first qubit and second qubit are in an entangled quantum state.

20. The system of any one of the preceding claims, wherein the first qubit frequency is different from the second qubit frequency.

21. The system of claim 20, wherein the first qubit frequency differs from the second qubit frequency by greater than 100 MHz.

22. The system of claim 20, wherein the first qubit frequency differs from the second qubit frequency by greater than 1 GHz.

23. The system of claim 20, wherein the first qubit frequency differs from the second qubit frequency by greater than 5 GHz.

24. The system of claim 20, wherein the first qubit frequency differs from the second qubit frequency by greater than 10 GHz.

25. The system of claim 20, wherein the first qubit frequency differs from the second qubit frequency by greater than 50 GHz.

26. The system of claim 20, wherein the first qubit frequency differs from the second qubit frequency by greater than 80 GHz.

27. The system of claim 20, wherein the first qubit frequency differs from the second qubit frequency by up to 150 GHz.

28. The system of any one of the preceding claims, further comprising a microwave source configured to provide a decoupling sequence to one or more of the first qubit or the second qubit to decouple the one or more of the first qubit or the second qubit from environmental noise.

29. The system of claim 28, wherein the decoupling sequence comprises a Hahn Echo sequence.

30. The system of any one of the preceding claims, further comprising a third qubit in proximity to the first qubit and a fourth qubit in proximity to the second qubit.

31. The system of claim 30, wherein the first qubit and the second qubit carry quantum information between the third qubit and the fourth qubit.

32. The system of claim 31, wherein the third qubit comprises a ¹³C or ²⁹Si nuclear spin.

33. The system of claim 31, wherein the fourth qubit comprises a ¹³C or ²⁹Si nuclear spin.

34. The system of any one of the preceding claims, wherein the interferometer provides the at least one second light beam to both the first qubit and the second qubit in a shared optical path.

35. The system of any of claims 1 to 33, wherein the interferometer provides the at least one second light beam to the first qubit in a first optical path and to the second qubit in a second optical path.

36. The system of any of claims 1 to 35, wherein the at least one second light beam comprises a second light beam and a third light beam, and wherein the interferometer provides the second light beam to the first qubit and the third light beam to the second qubit.

37. The system of any of claims 1 to 35, wherein the at least one second light beam comprises a single light beam, and wherein the interferometer provides the at least one second light beam to the first qubit and the second qubit in series.

38. A method of entangling a first qubit having an optical transition at a first qubit frequency and a second qubit having an optical transition at a second qubit frequency, the method comprising:
receiving with a first optical modulator a first light beam having at least a first frequency;
converting, with the first optical modulator, the first light beam into at least one second light beam, the at least one second light beam having at least a second frequency substantially matching the first qubit frequency and at least a third frequency substantially matching the second qubit frequency;
providing the at least one second light beam to one or more of the first qubit or the second qubit; and
producing, with a second optical modulator, an output light signal having at least a fourth frequency from the at least one second light beam.

39. The method of claim 38, wherein one or more of the first qubit or the second qubit comprise a silicon vacancy (SiV) qubit.

40. The method of claim 38, wherein one or more of the first qubit or the second qubit comprise a nitrogen vacancy (NV) qubit.

41. The method of claim 38, wherein one or more of the first qubit or the second qubit comprise a rare earth ion qubit.

42. The method of claim 38, wherein one or more of the first qubit or the second qubit comprise a quantum dot.

43. The method of claim 38, wherein one or more of the first qubit or the second qubit comprise a silicon carbide (SiC) defect.

44. The method of claim 38, wherein one or more of the first qubit or the second qubit comprise an optically active defect in a silicon crystal.

45. The method of any of claims 38 to 44, wherein one or more of the first optical modulator comprise an electro-optic modulator or an acousto-optic modulator.

46. The method of any of claims 38 to 44, wherein one or more of the second optical modulator comprise an electro-optic modulator or an acousto-optic modulator.

47. The method of any of claims 38 to 46, further comprising detecting the output light signal with a photon detector.

48. The method of claim 47, wherein the photon detector comprises a superconducting nanowire single photon detector.

49. The method of any of claims 38 to 48, wherein the output light signal further comprises at least one light beam having at least a fifth frequency and the method further comprises filtering the at least one light beam of at least the fifth frequency before the output light signal is detected by the photon detector.

50. The method of any of claims 38 to 49, further comprising applying microwaves of one or more of the first qubit frequency or the second qubit frequency to one or more of the first qubit or the second qubit.

51. The method of any of claims 38 to 50, wherein the first qubit reflects or transmits light based on the frequency of the light and a quantum state of the first qubit, and wherein the second qubit reflects or transmits light based on the frequency of the light and a quantum state of the second qubit.

52. The method of claim 51, wherein the second optical modulator shifts a frequency of the light that is transmitted from the first qubit and the second qubit and wherein the second optical modulator does not receive light that is reflected from the first qubit and the second qubit.

53. The method of claim 51, wherein the second optical modulator shifts a frequency of the light that is reflected from the first qubit and the second qubit and wherein the second optical modulator does not receive light that is transmitted from the first qubit and the second qubit.

54. The method of claim 52, wherein the output light signal is dependent on the quantum state of the first qubit and the quantum state of the second qubit such that:
when the first qubit and the second qubit are in the same quantum state, either light of the second frequency and light of the third frequency are reflected by the first qubit and the second qubit such that there is no light for the second optical modulator to produce the output light signal or light of the second frequency and light of the third frequency destructively interfere after being modulated by the second optical modulator; and
when the first qubit and the second qubit are in different quantum states, either light of the second frequency or light of the third frequency is transmitted to the second optical modulator such that the at least one second light beam is converted into the output light signal.

55. The method of any of claims 38 to 54, wherein the presence of the output light signal indicates that the first qubit and second qubit are in an entangled quantum state.

56. The method of any of claims 38 to 55, wherein the first qubit frequency is different from the second qubit frequency.

57. The method of claim 56, wherein the first qubit frequency differs from the second qubit frequency by greater than 100 MHz.

58. The method of claim 56, wherein the first qubit frequency differs from the second qubit frequency by greater than 1 GHz.

59. The method of claim 56, wherein the first qubit frequency differs from the second qubit frequency by greater than 5 GHz.

60. The method of claim 56, wherein the first qubit frequency differs from the second qubit frequency by greater than 10 GHz.

61. The method of claim 56, wherein the first qubit frequency differs from the second qubit frequency by greater than 50 GHz.

62. The method of claim 56, wherein the first qubit frequency differs from the second qubit frequency by greater than 80 GHz.

63. The method of claim 56, wherein the first qubit frequency differs from the second qubit frequency by up to 150 GHz.

64. The method of any of claims 38 to 63, further comprising performing a decoupling sequence on one or more of the first qubit or the second qubit to decouple the one or more of the first qubit or the second qubit from environmental noise.

65. The method of claim 64, wherein the decoupling sequence comprises a Haan echo sequence.

66. The method of any of claims 38 to 65, further comprising providing the at least one second light beam to both the first qubit and the second qubit in a shared optical path.

67. The method of any of claims 38 to 65, further comprising providing the at least one second light beam to the first qubit in a first optical path and to the second qubit in a second optical path.

68. The method of any of claims 38 to 67, wherein the at least one second light beam comprises a second light beam and a third light beam, and wherein the providing the least one second light beam to one or more of the first qubit or the second qubit comprises providing the second light beam to the first qubit and the third light beam to the second qubit.

69. The method of any of claims 38 to 67, wherein the at least one second light beam comprises a single light beam.
